(19) United States
(12) Patent Application Publication
(10) Pub. No.: US 2013/0018691 A1
(43) Pub. Date: Jan. 17, 2013

(54) MANAGEMENT SYSTEM AND MANAGEMENT METHOD

(71) Applicants: Yoshiki YUMBE, Kokubunji (JP); Takashi HASEGAWA, Kokubunji (JP)

(72) Inventors: Yoshiki YUMBE, Kokubunji (JP); Takashi HASEGAWA, Kokubunji (JP)

(73) Assignee: HITACHI, LTD., Tokyo (JP)

(21) Appl. No.: 13/570,369

(22) Filed: Aug. 9, 2012

(30) Foreign Application Priority Data
Jul. 15, 2011 (JP) 2011-156318

(51) Int. Cl. G06Q 10/10

(52) U.S. Cl. 705/7.21

(57) ABSTRACT

A management system for creating an inspection schedule of objects to be tested within a plurality of management areas, includes a calculation unit that calculates the costs for inspecting the objects to be tested based on the positional information; and a schedule creation unit that creates a schedule for inspecting the objects to be tested based on calculation results. The calculation unit calculates a first cost required when the objects to be tested within the management areas are inspected at the same timing within a first time limit, and a second cost required when a part of the objects to be tested within the management areas is inspected within the first time limit, individually, and the other objects to be tested within the management areas are inspected at the same timing within a second time limit longer than the first time limit.

### CLAIMS OF PRIORITY

The present application claims priority from Japanese patent application JP 2011-156318 filed on Jul. 15, 2011, the content of which is hereby incorporated by reference into this application.

### FIELD OF THE INVENTION

The present invention relates to a system for scheduling and managing the maintenance of facilities, and more particularly to a management system and a management method, which output a schedule for efficiently maintaining a large number of facilities which are particularly scattered in a wide range such as utility poles in power distribution facilities.

### BACKGROUND OF THE INVENTION

Most of apparatus industries and society's infrastructures have confronted such a problem that the costs necessary to maintain physical facilities that are naturally deteriorated are increased while there is a limit to the costs for maintaining those physical facilities. Under the circumstances, interest in an EAM (enterprise asset management) system that comprehensively assists an approach to the facility maintenance by an IT (information technology) has grown. In particular, in order to efficiently maintain a large number of facilities scattered in a wide range, it is important to reduce the inspection and checking costs which are costliest. As a technique for reducing the inspection costs, Japanese Unexamined Patent Application Publication No. 2010-097392 discloses a method for predicting the deterioration of the facilities to determine a priority order of inspection.

Also, Japanese Unexamined Patent Application Publication No. 2009-277109 discloses a method for determining an inspection order in a maintenance area by the aid of facility deterioration prediction results.

### SUMMARY OF THE INVENTION

In the method for predicting the deterioration of the facilities, the inspection priority order can be obtained for each of objects to be maintained. However, there is no disclosure of a method for obtaining a real inspection schedule according to a determined priority order.

Also, in the method for implementing and managing the inspection schedule disclosed in Japanese Unexamined Patent Application Publication No. 2009-277109, the priority order is determined for each of the maintenance areas by the aid of the inspection priority order for each of the objects to be maintained such as the facility deterioration prediction results, and the inspection order can be determined by the aid of the same results even in the maintenance area. However, because an object to be tested low in the priority order is inspected in a later order, the inspection costs are not reduced as compared with a case in which all of inspections are conducted without determining the priority order. Further, because the priority order in the maintenance area is set to the order of the object to be tested highest in the priority order within that area, if the number of objects higher in the priority order within the area is small, other objects to be tested low in the priority order are also tested preferentially for the objects to be tested high in the priority order, resulting in a problem that the inspection of the object to be tested high in the priority order in other areas is relatively delayed.

Also, Japanese Unexamined Patent Application Publication No. 2009-277109 discloses a method for determining the inspection order according to the inspection priority order for each object to be maintained such as the facility deterioration prediction results regardless of the maintenance area.

However, in that case, the costs required for the inspection increase as compared with a case in which the adjacent objects to be tested are inspected without determination of the priority order if an interval between the objects to be tested, which are adjacent to each other in the order is long. This is because the inspection costs depend on not only the number of objects to be tested, but also a time for moving between the respective objects to be tested. If the objects to be tested high in the priority order are merely inspected, a time for moving between the respective objects to be tested increases, resulting in an increase in the inspection costs. Also, the number of objects to be tested is more increased as the maintenance area is wider. Accordingly, it is difficult to appropriately determine whether an appropriate object to be tested should be inspected at this time, or later, in order to reduce the costs required for inspection.

As described above, if the object to be tested high in the priority order is included in a temporary inspection route, the costs of the temporary inspection increase. However, because a regular inspection defining an arbitrary period, that is, a time limit of inspection is also conducted, the costs are not reduced unless the costs of the temporary inspection and the regular inspection are comprehensively taken into consideration.

A typical example of the present invention disclosed in the present application will be described below. That is, there is provided a management system for creating an inspection schedule of objects to be tested within a plurality of sectioned management areas, including: a database that stores an inspection time limit and positional information of the objects to be tested; a calculation unit that calculates the costs for inspecting the objects to be tested on the basis of the positional information; and a schedule creation unit that creates a schedule for inspecting the objects to be tested on the basis of calculation results, in which the calculation unit calculates a first cost required when the objects to be tested within the management areas are inspected at the same timing within a first time limit, and a second cost required when a part of the objects to be tested within the management areas is inspected within the first time limit, individually, and the other objects to be tested within the management areas are inspected at the same timing within a second time limit longer than the first time limit, and the schedule creation unit compares the calculated first costs with the calculated second costs, and creates an inspection schedule in which the time limits when the objects to be tested within each of the management areas are inspected are combined with the objects to be tested, individually, on the basis of comparison results.

According to the typical aspect of the present invention, the management can be provided which can reduce the comprehensive costs for the objects to be tested arranged in the plurality of areas.

### BRIEF DESCRIPTION OF THE DRAWINGS

FIG. 1 is a diagram illustrating an example of a system configuration of a schedule optimization system for power distribution facilities inspections according to a first embodiment;

FIG. 2 is a flowchart illustrating an example of a schedule optimization method for power distribution facilities inspections according to the first embodiment;

FIG. 3 is a diagram illustrating an example of a configuration of history data according to the first embodiment;

FIG. 4 is a diagram illustrating an example of a configuration of facilities status data according to the first embodiment;

FIG. 5 is a diagram illustrating an example of a configuration of management data according to the first embodiment;

FIG. 6 is a flowchart illustrating an example of an inspection priority calculation method according to the first embodiment;

FIG. 7 is a flowchart illustrating an example of processing for converting inspection priority calculation results into data to be input to an inspection schedule creation unit according to the first embodiment;

FIGS. 8A and 8B are diagrams illustrating an example of a layout of inspection areas on a map, and objects to be inspected which are sectioned in the area, respectively;

FIG. 9A is a diagram illustrating the layout of the inspection areas on the map, and FIG. 9B is a diagram illustrating an example of the results obtained by calculating the inspection priorities of facilities within an area m;

FIG. 10A is a diagram illustrating the layout of the inspection area on the map, and FIG. 10B is a diagram illustrating a concept of an inspection method having individual inspection and area inspection combined together;

FIGS. 11A and 11B are diagrams illustrating a method in which the individual inspections are combined together to extend an interval between the area inspections;

FIG. 12 is a diagram illustrating an example of an inspection schedule in which the inspection intervals and the individual inspection groups are combined together, which minimizes the inspection costs of the overall plural inspection areas;

FIG. 13 is a diagram illustrating an example of the configuration of the area inspection costs;

FIGS. 14A to 14D are diagrams illustrating specific examples of calculation of a determination reference value for extending the area inspection intervals;

FIG. 15 is a flowchart illustrating an example of inspection schedule creation processing according to the first embodiment;

FIG. 16 is a diagram illustrating a specific example of the inspection schedule creation processing illustrated in FIG. 15;

FIG. 17 is a diagram illustrating a specific example of the inspection schedule creation processing illustrated in FIG. 15;

FIG. 18 is a diagram illustrating a specific example of the inspection schedule creation processing illustrated in FIG. 15;

FIG. 19 is a diagram illustrating a specific example of the inspection schedule creation processing illustrated in FIG. 15;

FIG. 20 is a diagram illustrating a specific example of the inspection schedule creation processing illustrated in FIG. 15;

FIG. 21 is a diagram illustrating a specific example of the inspection schedule creation processing illustrated in FIG. 15;

FIG. 22 is a diagram illustrating an example of the configuration of area inspection schedule data according to the first embodiment;

FIG. 23 is a diagram illustrating an example of the configuration of area inspection schedule data according to the first embodiment;

FIG. 24 is a diagram illustrating an example of a schedule optimization system GUI for power distribution facilities inspections;

FIG. 25 is a diagram illustrating an example of the GUI in which a map is largely displayed on an inspection schedule display page;

FIG. 26 is a diagram illustrating an example of the GUI in which an area inspection schedule is displayed on the inspection schedule display page;

FIG. 27 is a diagram illustrating an example of the GUI in which an inspection route within an inspection area is displayed on the inspection schedule display page;

FIG. 28 is a diagram illustrating an example of the GUI in which an individual inspection schedule is displayed on the inspection schedule display page;

FIG. 29 is a diagram illustrating an example of the GUI in which an inspection route within the individual inspection group is displayed on the inspection schedule display page;

FIG. 30 is a diagram illustrating an example of the GUI on a graph display page;

FIG. 31 is a flowchart illustrating an example of inspection schedule creating processing according to a second embodiment;

FIG. 32 is a diagram illustrating a specific example of the inspection schedule creation processing according to the second embodiment;

FIG. 33 is a flowchart illustrating an example of inspection schedule creating processing according to a third embodiment;

FIG. 34 is a diagram illustrating a specific example of the inspection schedule creation processing according to the third embodiment; and

FIG. 35 is a diagram illustrating a specific example of the inspection schedule creation processing according to the third embodiment.

### DETAILED DESCRIPTION OF THE PREFERRED EMBODIMENTS

Hereinafter, embodiments of the present invention will be described with reference to the accompanying drawings.

### First Embodiment

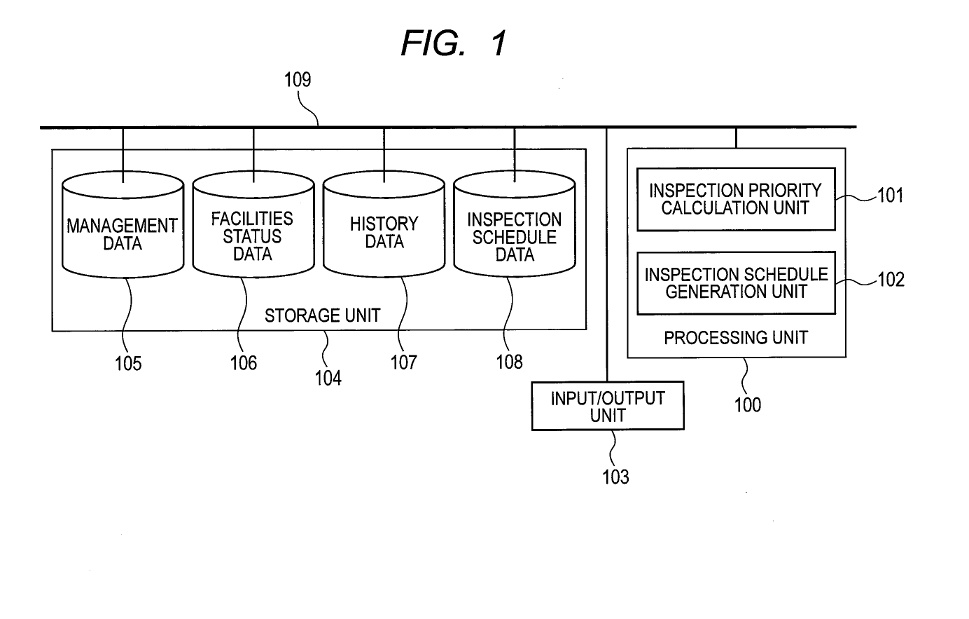

First, a configuration of a schedule optimization system for power distribution facilities inspections according to a first embodiment of the present invention will be described with reference to FIG. 1.

The schedule optimization system for power distribution facilities inspections according to the first embodiment is a computer system having a processing unit (100) that obtains an optimized inspection schedule, a storage unit (104) that stores a variety of data, and an input/output unit (103) that outputs an optimized inspection schedule. The storage unit (104) is a memory or nonvolatile storage device (for example, magnetic disc drive, flash memory) that stores history data (107), facilities status data (106), management data (105), and inspection schedule data (108). The processing unit (100) is realized by allowing a processor to execute a given program. The program to be executed by the processor is stored in a memory (not shown). The processing unit (100), the storage unit (104) and the input/output unit (103) are connected by a communication route (109). The input/output unit (103) includes a display screen that displays the results of processing, a keyboard through which a user conducts input operation, a mouse, and a network interface for connection to another computer.

The history data (107) includes a failure history and a use history of facilities to be inspected. When the facilities to be inspected are utility poles of the power distribution facilities, the history data (107) is the failure history of devices (pole-mounted transformers) installed on the utility poles, and may include an exchange history of the components, and an accumulated electric energy. Also, the facilities status data (106) is the environment of an installation location of each facility to be inspected, and may include information on installation date. When the facilities to be inspected are utility poles of the power distribution facilities, the facilities status data (106) may be the installation date of the utility poles and the devices installed on the utility poles, and the environment (for example, salt damage areas, strong wind areas, severe thunder areas, etc.) of the installation locations. Also, the management data (105) is an influence rate when an accident occurs. When the facilities to be inspected are utility poles of the power distribution facilities, the management data (105) is the influence rate determined on the basis of the number of consumers to which an electric power is supplied through distribution lines connected to the utility poles, and the degree of importance of the consumers. The inspection schedule data (108) will be described later.

Subsequently, the operation of the schedule optimization system for power distribution facilities inspection's according to the first embodiment will be described with reference to FIGS. 1 and 2.

First, an inspection priority calculation unit (101) predicts an inspection priority for each of the facilities to be inspected by the aid of the history data (107), the facilities status data (106), and the management data (105), and stores the inspection priority into the facilities status data (106) (200). Then, an inspection schedule creation unit (102) obtains the optimum combination of the inspection interval and the individual inspection group by the aid of the predicted inspection priority, stores the combination as the inspection schedule in the inspection schedule data (108) therein, and outputs the inspection schedule data (108) to the input/output unit (103) (201).

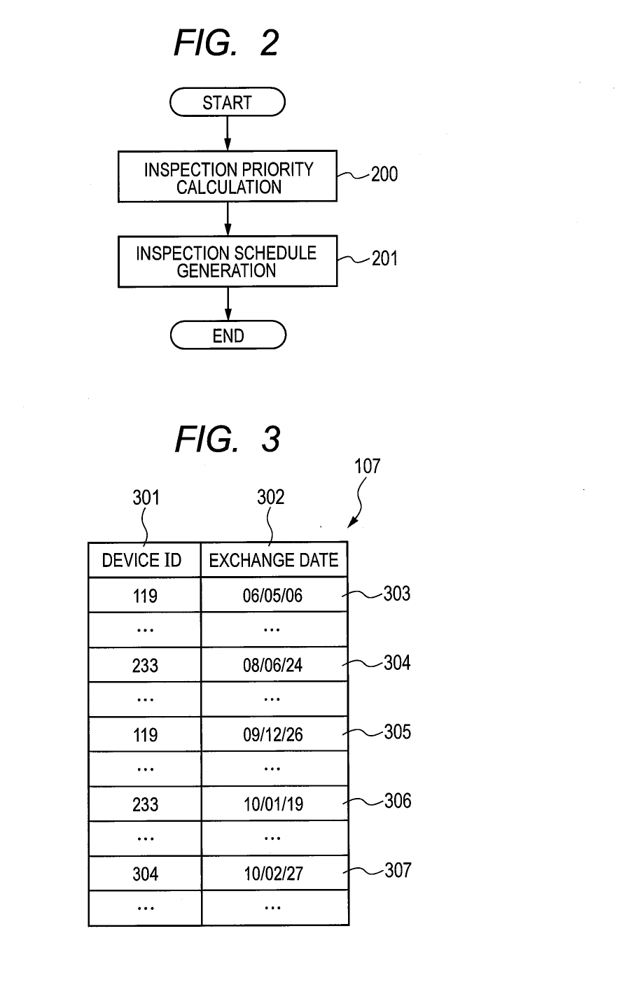

Subsequently, the history data (107), the facilities status data (106), and the management data (105) used in the inspection priority calculation (200) will be described with reference to FIGS. 3, 4, and 5.

As illustrated in FIG. 3, the history data (107) includes a failure history that associates identifiers (301) of the devices to be inspected with exchange date (302) resulting from the deterioration of the devices. For example, data 303 represents that a device having the device ID of 119 has been exchanged due to the deterioration of the device on May 6, 2006.

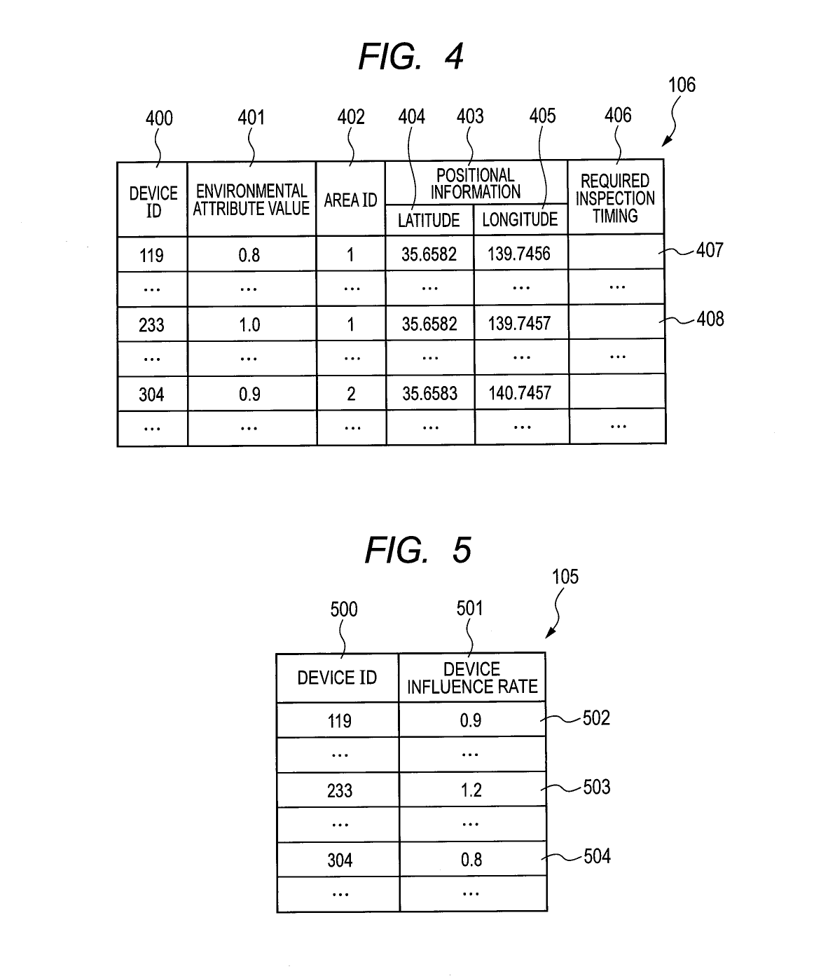

As illustrated in FIG. 4, the facilities status data (106) includes the facilities status in which an identifier (400) of the device to be inspected, an environmental attribute value (401), an identifier (402) of the maintenance area, positional information (403), and a next inspection timing (406) are associated with each other.

The environmental attribute value (401) is a coefficient of the failure interval due to the installation environment of the device, and indicates that the device is installed under the environment where the device is liable to fail more as a positive value of 1.0 or lower is smaller. For example, because a device (408) having the device ID of 233 is installed under the normal environment, 1.0 is recorded in the environmental attribute value (401). On the other hand, because a device (407) having the device ID of 119 is installed under the environment where failure is liable to occur more than the normal, 0.8 smaller than 1.0 is recorded in the environmental attribute value (401). When the facilities to be inspected are the utility poles of the power distribution facilities, the environment where the failure is liable to occur more than the normal is the salt damage areas, the strong wind areas, or the severe thunder areas. The environmental attribute value (401) may be determined on the basis of the past failure history, or may be estimated from a state of the device installed under the similar environment.

The identifier (402) of the maintenance area is an identifier of the maintenance area having the facilities to be inspected. In an example illustrated in FIG. 4, data (407 and 409) indicates that the device having the device ID of 119 and the device having the device ID of 233 are included in an area having an area ID of 1.

In the positional information (403), positional information indicative the installation position of the facilities to be inspected is recorded. In the example illustrated in FIG. 4, the positional information (403) includes a latitude (404) and a longitude (405) of the installation position. For example, the data (407) represents that the device having the device ID of 119 is installed at a position of a north latitude of 35.6582 degrees and an east longitude of 139.7456 degrees.

In the next inspection timing (406) of the device, a next inspection timing where the results of the inspection priority calculation (200) has been converted is recorded. The next inspection timing is used as an input of the inspection schedule creation (201).

As illustrated in FIG. 5, in the management data (105), identifiers (500) of the devices and device influence rates (501) are recorded in association with each other. The device influence rate (501) represents the influence rate of a failure of the subject device on business, and is normally 1.0. If the influence is large, a value larger than 1.0 is recorded according to the degree of influence (503). If the influence is small, a value smaller than 1.0 is recorded according to the degree of influence (504). For example, when the inspection target is the utility poles of the power distribution facilities, if an electric power is supplied to a large number of supply targets through the distribution lines supported by the utility poles, an influence of the failure of the utility poles on customers is large. Therefore, the device influence rate (501) becomes a large value. Also, when the customer to which the electric power is supplied through the distribution lines supported by the utility poles is an important facility such as a hospital, the influence of the failure of the utility poles on the customer is large. Therefore, the device influence rate (501) becomes a large value.

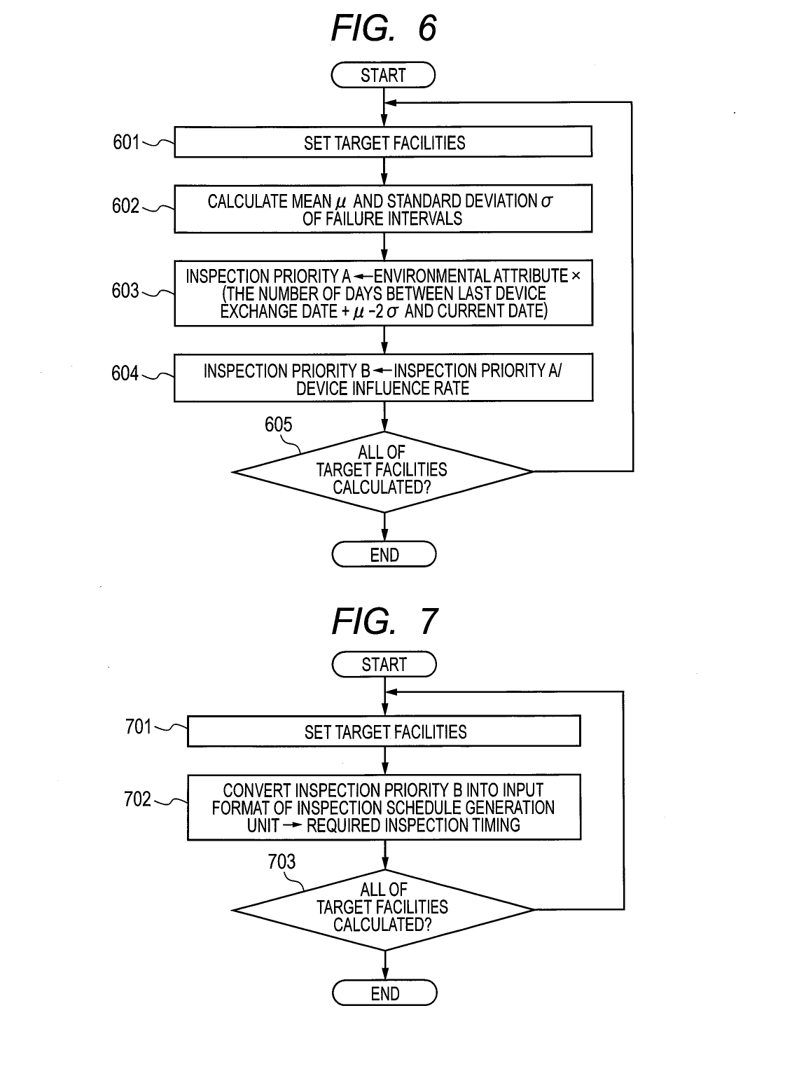

Subsequently, the inspection priority calculation processing (200) that is conducted by the inspection priority calculation unit (101) will be described with reference to FIGS. 3, 4, 5, and 6.

First, the inspection priority calculation unit (101) sets the facility to be calculated (601), first calculates an average μ of the failure intervals and a standard deviation a (602), and records a value obtained by multiplying a difference between a date after μ-2σ from a last device exchange date and the current day by an environmental attribute as an inspection priority A (604). In the present specification, the failure interval is a difference between adjacent exchange dates (301) in the device having the same device ID (301). For example, in the example illustrated in FIG. 3, in the device having the device ID of 119, 1999/5/6 is recorded as the device exchange date (303), and 2009/12/26 is recorded as the next device exchange date (305). Therefore, the failure interval is 1331 days which are a difference between those exchange dates. Also, in the device having the device ID of 233, 2008/6/24 is recorded as the device exchange date (304), and 2010/1/19 is recorded as the next device exchange date (306). Therefore, the failure interval is 575 days which are a difference between those exchange dates.

Also, the last device exchange date is a latest device exchange date in the device having the same device ID (301), that is, the maximum value of the device exchange date. For example, in the example illustrated in FIG. 3, in the device having the device ID of 119, 2009/12/26 is the last device exchange date (305), and in the device having the device ID of 223, 2010/1/19 is the last device exchange date (306).

Also, when the average of the failure intervals of the device having the device ID of 119 is 1300 days, and the standard deviation is 60 days, μ-2σ (1330−60×2=1210) days after the last exchange date are 2013/4/19, and this date is the earliest available date of the predicted device exchange date. For example, when it is assumed that the current day is 2010/4/1, a difference in day from the current date is 1114 days, and the environmental attribute value (401) of the device having the identifier (400) of 119 is 0.8. Therefore, the inspection priority A is 0.8×1114=891.2.

Then the inspection priority A is divided by the device influence rate, and a divided value is set as an inspection priority B (604). For example, with the use of the inspection priority A=891.2 of the device having the device ID of 119, and the inspection priority A=0.9 of the device having the device ID of 119, the inspection priority B is 891.2/0.9=990.2. Since the inspection priorities A and B represent whether it is closer to the failure, or not, the priority becomes higher as the value is smaller. Those processing 601 to 604 is repeated for all of the devices ID (605).

Subsequently, a description will be given of processing of converting the inspection priority B of each device which is the output result of the inspection priority calculation unit (101) into an input format of the inspection schedule creation unit (102) with reference to FIGS. 4 and 7.

First, the facility to be inspected is set (701), and the inspection priority B of the target facility is converted into an input format of the inspection schedule creation unit (102). For example, the inspection priority B=990.2 of the device having the device ID of 119 represents the number of days until the device subsequently fails, which is converted into the number of years, that is, about 2.7 years. The 2.7 years are truncated or rounded off as the next inspection timing. When the 2.7 years are truncated, the next inspection timing of the device having the device ID of 119 is 2 years later, and when the 2.7 years are truncated or rounded off as the next inspection timing. When the 2.7 years are rounded off, the next inspection timing of the device having the device ID of 119 is 3 years later. This may be appropriately selected by trading off the reliability and the inspection costs. Those processing 701 to 702 are repeated for all of the devices ID (703). The calculated next inspection timing is stored in the next inspection timing (406) of the facilities status data (106).

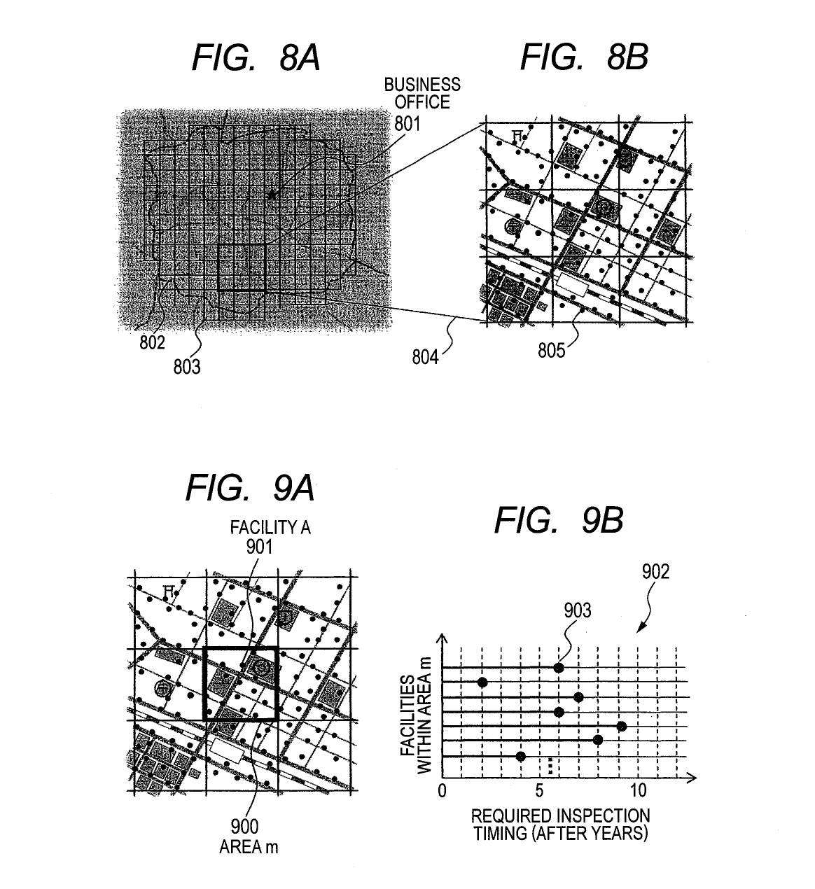

Subsequently, a description will be given of an example of maintenance operation of a large number of facilities scattered in a wide range according to this embodiment with reference to FIGS. 8A and 8B.

As illustrated in FIG. 8A, in this embodiment, a business office (801) has a territory (802), divides the territory (802) into a plurality of maintenance areas (803), and manages the facilities installed in each of the maintenance areas (803). As illustrated in FIG. 8B, a plurality of facilities (805) is installed in each of the maintenance areas (803), and each of the maintenance areas (803) is inspected according to the inspection interval for each of the maintenance areas defined by this embodiment. For example, when the next inspection timing is 3 years later, the target area is inspected 3 years after the current time. The inspection is conducted in a procedure in which a patrolman goes an area to be inspected from the business office (801), inspects the facilities within the area, returns to the. business office (801), and reports the inspection result. In this embodiment, the maintenance area (inspection area) to be inspected is a square, and sectioned into a grid pattern. The size, the configuration, and the layout of the maintenance area may be changed according to the installation status of the facilities.

Subsequently, an example of the inspection priority calculation (200) results will be described with reference to FIGS. 4 and 9A, 9B.

As illustrated in FIG. 9(A), a plurality of facilities is installed in a maintenance area m (900), and when the inspection priority is calculated for those facilities 200), the next inspection timing of each facility within the maintenance area m (900) is calculated. FIG. 9B illustrates a distribution (902) of the calculated next inspection timing.

The distribution (902) can be created by extracting the next inspection timing data having the ID of k from the facilities status data (106). The axis of abscissa represents years, and the axis of ordinate represents the respective facilities. For example, referring to the distribution (902) of the next inspection timing, it is found that a next inspection timing (903) of a facility A (901) is 6 years. The next timing necessary to inspect the respective facilities within the maintenance area can be thus calculated by the inspection priority calculation (200).

Subsequently, the processing of the inspection schedule creation unit (102) will be described with reference to FIGS. 9A, 9B to 12.

In this embodiment, when a small number of facilities high in the inspection priority A exist in the inspection area, those facilities to be inspected are excluded from the area inspection target, and allowed to be included in the individual inspection group. As a result, the inspection intervals of the remaining facilities to be inspected within the inspection area are increased for each area, and the inspection costs are reduced. The facilities to be inspected are excluded from the area inspection target, and allowed to be included in the individual inspection group with the result that the inspection interval for each area can be increased. For that reason, the costs of the area inspection can be reduced, but the costs of the individual inspection are increased. Under the circumstances, in this embodiment, the combination (optimum inspection schedule) of the inspection interval and the individual inspection group for each area which minimizes the total inspection costs in the plurality of areas is obtained to optimize the total inspection costs.

First, a description will be given of the maintenance area m (900) used as an example when describing the summary of the processing in the inspection schedule creation unit (102). As a result of calculating the inspection priority for the facilities within the maintenance area m (900) (200), the distribution (902) of the next inspection timing of the facilities within the maintenance area m (900) is obtained. The next inspection timing distribution (902) can be created by extracting the next inspection timing data of the device having the device ID of m from the facilities status data (106), and the axis of abscissa represents years, and the axis of ordinate represents the respective facilities.

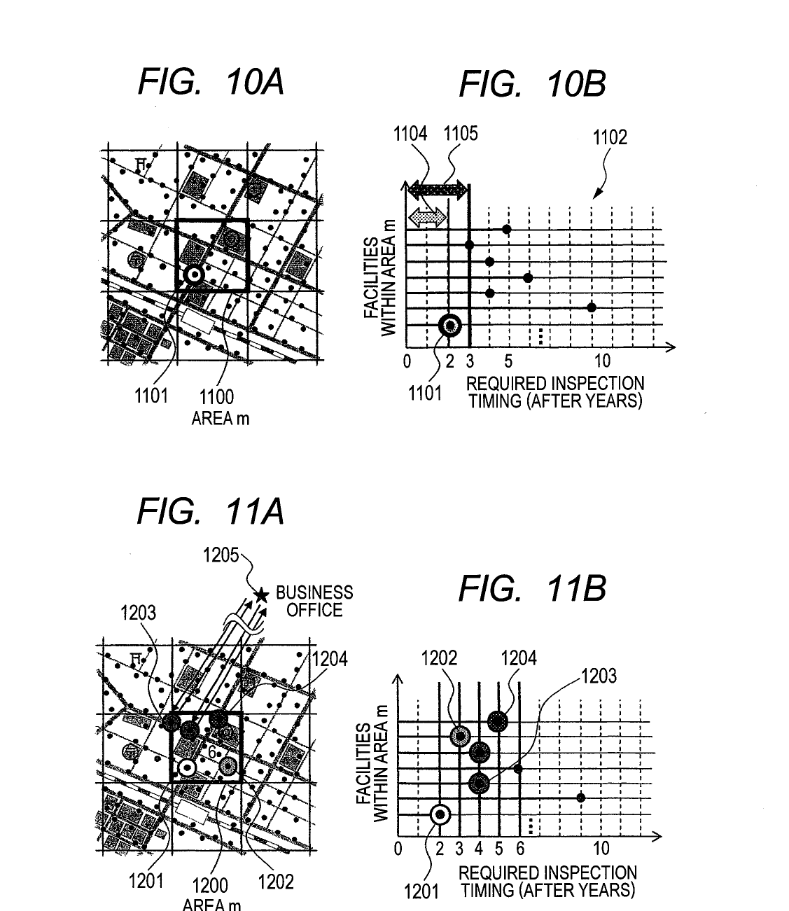

A in FIGS. 9A and 9B, FIGS. 10A and 10B illustrate a maintenance area m (1100) and a distribution (1102) of the next inspection timing of the facilities within the maintenance area m, respectively. When the inspection interval of the maintenance area m is set to 2 years (1104), a facility 1101 predicted to be required to be inspected 2 years later is included in the maintenance area m (1100). For that reason, the facility (1101) high in the inspection priority is excluded from the area inspection target, and inspected 2 years later, individually, aside from the area inspection. As a result, the inspection interval of the maintenance area m can be extended to 3 years (1105).

When the method described with reference to FIGS. 10A and 10B is further applied to the area m illustrated in FIG. 11A, if the inspection interval of an area m (1200) is set to 2 years (1104) as illustrated in FIG. 11B, a facility 1201 is inspected 2 years later, individually, as a result of which the interval of the area inspection can be extended from 2 years to 3 years. A facility 1202 is inspected 3 years later, individually, as a result of which the interval of the area inspection can be extended from 3 years to 4 years. A facility 1203 is inspected 4 years later, individually, as a result of which the interval of the area inspection can be extended from 4 years to 5 years. A facility 1204 is inspected 5 years later, individually, as a result of which the interval of the area inspection can be extended from 5 years to 6 years.

Thus, the facilities required to be inspected earlier than the timing of the current area inspection are changed to the individual inspection, and inspected from a business office 1205, individually, aside from the area inspection with the result that each interval of the area inspection is extended by 1 year. Further, the facilities to be inspected, individually, are grouped across a boundary of the area for each year such as 2 years later, 3 years later, . . . , and the individual inspection group where inspection is conducted at once is generated. As a result, the travel costs required for inspection can be reduced.

A period till the next area inspection is lengthened so that the costs of the area inspection can be reduced. However, the inspection costs of the facilities newly set as the individual inspection are increased. Also, the individual inspection costs are increased or decreased even depending on how to group the facility group to be subjected to the individual inspection. Under the circumstances, the optimum inspection schedule of the combination of the inspection interval and the individual inspection group in each area, which minimizes the total inspection costs in the plurality of areas, is obtained, and the total inspection costs are reduced.

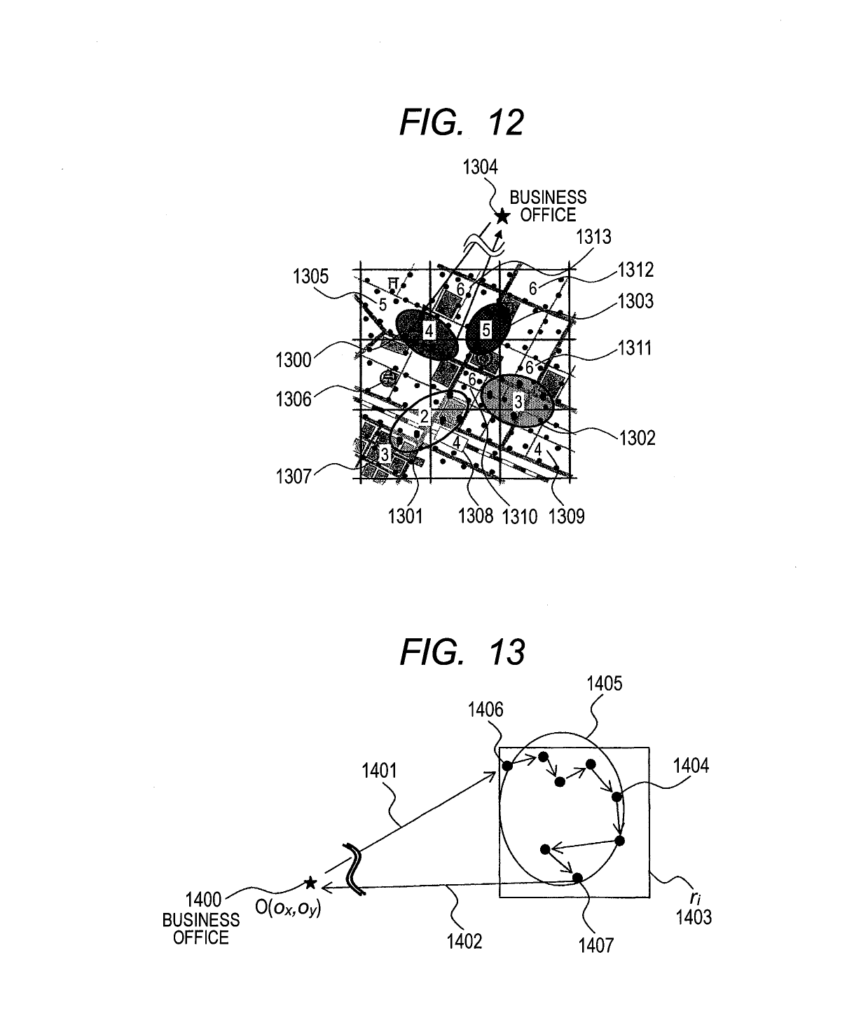

FIG. 12 is a diagram illustrating an example of the calculation results of the inspection schedule in which the inspection intervals and the individual inspection groups are combined together for each area, which is optimum for the plurality of maintenance areas.

In the inspection schedule illustrated in FIG. 12, the inspection interval is determined for each area. The inspection interval of an area 1305 is 5 years, inspection interval of an area 1306 is 5 years, inspection interval of an area 1307 is 3 years, the inspection interval of an area 1308 is 4 years, the inspection interval of an area 1309 is 4 years, the inspection interval of an area 1310 is 6 years, inspection interval of an area 1311 is 6 years, the inspection interval of an area 1312 is 6 years, and the inspection interval of an area 1313 is 6 years. Also, individual inspection groups different in the inspection timing, that is, a two-year later individual inspection group 1301, a three-year later individual inspection group 1302, a four-year later individual inspection group 1303, and a five-year later individual inspection group 1304 are determined.

Subsequently, a description will be given of a specific method for obtaining the schedule in which the inspection interval and the individual inspection group are combined together for each area which minimizes the total inspection costs in the plurality of areas, which is optimum for minimizing the total inspection costs in the plurality of areas, with reference to FIGS. 13 to 23, and Expressions 1 to 12.

In this embodiment, the costs are calculated for one case in which the area inspection costs and the individual inspection costs are modeled, and all of the facilities to be subjected to the area inspection are inspected at the current area inspection interval for the respective maintenance areas at the same time, and another case in which a part of the facilities to be inspected is extracted, and inspected, individually, to extend the area inspection interval, and the remaining facilities to be subjected to the area inspection are subjected to the area inspection. Then, both of the costs are compared with each other to provide, for each maintenance area, a decision reference value for deciding whether all of the facilities to be subjected to the area inspection should be inspected at the current area inspection interval at the same time, or a part of the facilities to be inspected should be extracted and inspected, individually, to extend the area inspection interval, and the other facilities to be subjected to the area inspection should be subjected to the area inspection. The inspection interval and the individual inspection group are determined for each of the maintenance areas on the basis of the decision reference value, to calculate the schedule for minimizing the total inspection costs of the plurality of areas.

First, the modeling of the area inspection costs will be described with reference to FIG. 13 and Expressions 1 to 11.

A set R of the maintenance areas rᵢ, that is, a territory of a given business office is represented by Expression 1. As represented by Expression 2, the maintenance area rᵢ is expressed by a facility set Pᵢ and an inspection interval Yᵢ of the maintenance area as represented by Expression 2. Further, as represented by Expression 3, Pᵢ is expressed as a set of facilities pⱼ, and as represented by Expression 4, the facilities pⱼ include coordinates (Xⱼ, Yⱼ) of the installation positions of the facilities.

R={r₀,r₁, . . . ,rᵢ, . . . ,r_{N-1}} (1)

rᵢ={Pᵢ,yᵢ} (2)

Pᵢ={p₀,p₁, . . . ,pⱼ, . . . ,P_{M-1}} (3)

pⱼ=(Xⱼ,Yⱼ) (4)

Under the above conditions, the area inspection costs in a given maintenance area rᵢ is represented by Expression 5. Area inspection costs Cᵣ(rᵢ) of the area rᵢ per one year can be calculated by the aid of Expression 5. That is, the area inspection costs Cᵣ (rᵢ) of the area rᵢ per one year is calculated by divided a sum of a time α(Pᵢ) required for testing the facilities, a time β(Pᵢ) required for inspection movement between the respective facilities, and a reciprocating movement time γ(Pᵢ) between the business office and the area rᵢ by the inspection interval yᵢ of the area rᵢ.

$${C}_{r} ( {r}_{i} ) = \frac{α ( {P}_{i} ) + β ( {P}_{i} ) + γ ( {P}_{i} )}{{y}_{i}} \qquad ( 5 )$$

FIG. 13 illustrates an area inspection cost model expressed in Expression 5. A plurality of facilities to be inspected (1404) is installed within the area rᵢ (1403). When the area rᵢ is inspected, a patrolman goes from a business office O (1400) to a first facility to be inspected (1406) within the area ri (1403) (1401), travels the facilities to be inspected within the area rᵢ (1403) (1405), and returns from a last facility to be inspected (1407) to the business office O (1400) (1402). In the inspection of the area rᵢ (1403), a reciprocating time (1401 and 1402) to the area rᵢ corresponds to a reciprocating movement time γ(Pᵢ) between the business office and the area in Expression 5, and a time α(Pᵢ) required to check whether there is an abnormality in the facilities to be inspected within the area, or not, and a travel time (1405) between the adjacent facilities corresponds to a time β(Pᵢ) required for travel movement between the facilities.

The time α(Pᵢ) for checking the facilities is represented by Expression 6. In Expression 6, reference symbol A is a check time per facility, and M is the number of facilities installed within the area rᵢ. The check time A may be a fixed value in all of the facilities, or may be a value different for each of the facilities. When the facilities to be inspected are the utility poles of the power distribution facilities, ancillary equipments are different for each of the utility poles. Therefore, the check time A per facility may be determined according to the number and type of devices. Also, because the check time A per facility is also changed according to the capability of the patrolman, the check time A may be changed according to the capability of the patrolman.

α(Pᵢ)=A·M (6)

A movement time β(Pᵢ) between the facilities is represented by Expression 8. In Expression 8, dₘᵢₙ is a travel distance having the shortest movement distance in the travel routes of the facilities to be inspected within the area rᵢ, and dₘᵢₙ is represented by Expression 7. In Expression 7, σ(n) represents an n-th facility of a permutation representing a route for traveling the target facilities from the business office, and do dσ₍ₙ₎σ₍ₙ₊₁₎ is a distance between the n-th facility and an (n+1)-th facility in the permutation.

A problem for obtaining dₘᵢₙ is a general traveling salesman problem, and as the number of travel targets is increased more, it is difficult to obtain a strict solution. For that reason, a solution for obtaining an approximate solution at a realistic time (for example, local search method, generic algorithm, simulated annealing method, etc.) has been proposed. The dₘᵢₙ can be calculated by the above methods. The dₘᵢₙ is obtained by subtracting, from dₘᵢₙ, the movement distance dσ₍₀₎σ₍₁₎ from the business office to the first facility to be inspected within the area rᵢ, and the movement distance dσ_{(M)}σ(₍₀₎ from the last facility to be inspected to the business office. That is, the dₘᵢₙ is obtained by multiplying the movement distance for traveling the facilities within the area rᵢ by the movement time B per a unit distance.

$$\begin{matrix}{d}_{min} = min ( {\sum }_{n = 0}^{M - 1} {d}_{σ ( n ) σ ( n + 1 )} + {d}_{σ ( M ) σ ( 0 )} ) \\ where σ ( 0 ) = 0 & ( 7 ) \\ β ( {P}_{i} ) = B \cdot ( {d}_{min} - {d}_{σ ( 0 ) σ ( 1 )} - {d}_{σ ( M ) σ ( 0 )} ) & ( 8 )\end{matrix}$$

Also, the reciprocating movement time γ(Pᵢ) between the business office and the area is represented by Expression 9. That is, the reciprocating movement time γ(Pᵢ) is a sum of the movement distance dσ₍₀₎σ₍₁₎ from the business office to the first facility to be inspected within the area rᵢ, and the movement distance dσ_{(M)}σ₍₀₎ from the last facility to be inspected to the business office, that is, obtained by multiplying the reciprocating movement distance between the business office and the area rᵢ by a movement time C per a unit distance. When there is a set G of the individual inspection groups gᵢ represented by Expression 10 within the territory, and each group gᵢ can be expressed by Expression 11 as with the area rᵢ, the traveling costs C_{g}(gᵢ) of the individual inspection group gᵢ can be expressed in the same format as that of Expressions 5 to 9.

γ(Pᵢ)=C·(d_{σ(0)σ(1)}+d_{σ(M)σ(0)}) (9)

G={g₀,g₁, . . . ,gᵢ, . . . ,g_{N}_{_{g}}₋₁} (10)

gᵢ={P_{i,},yᵢ} (11)

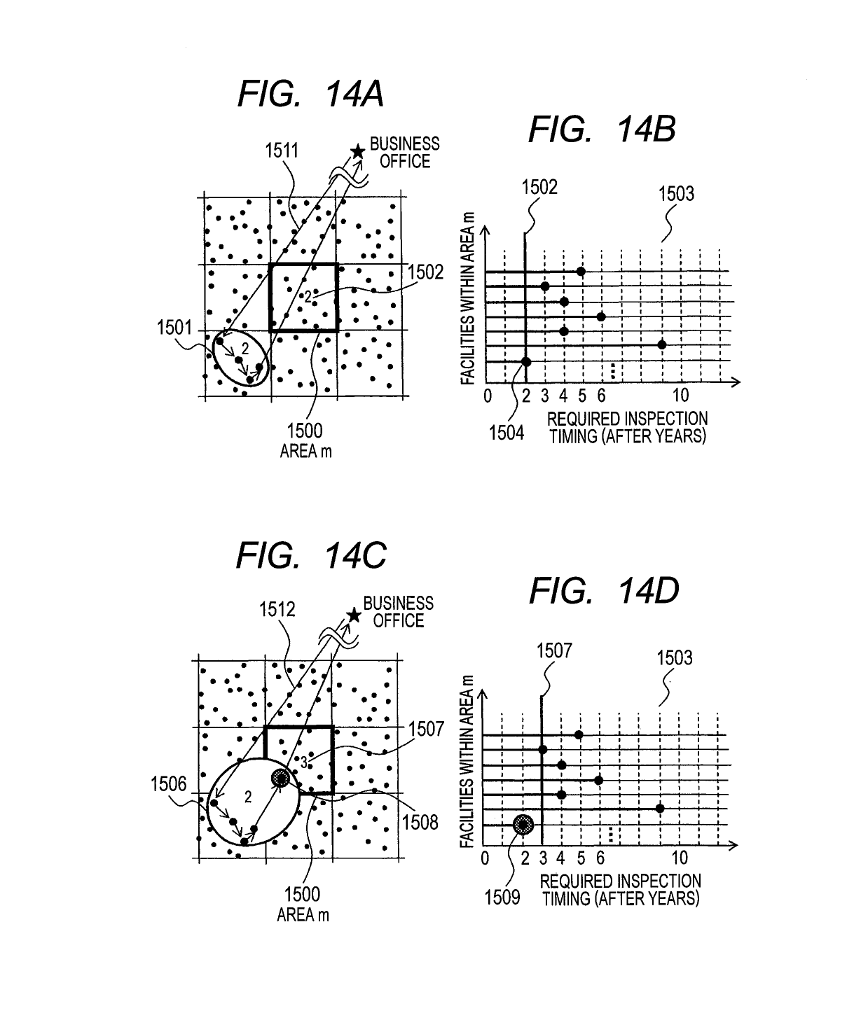

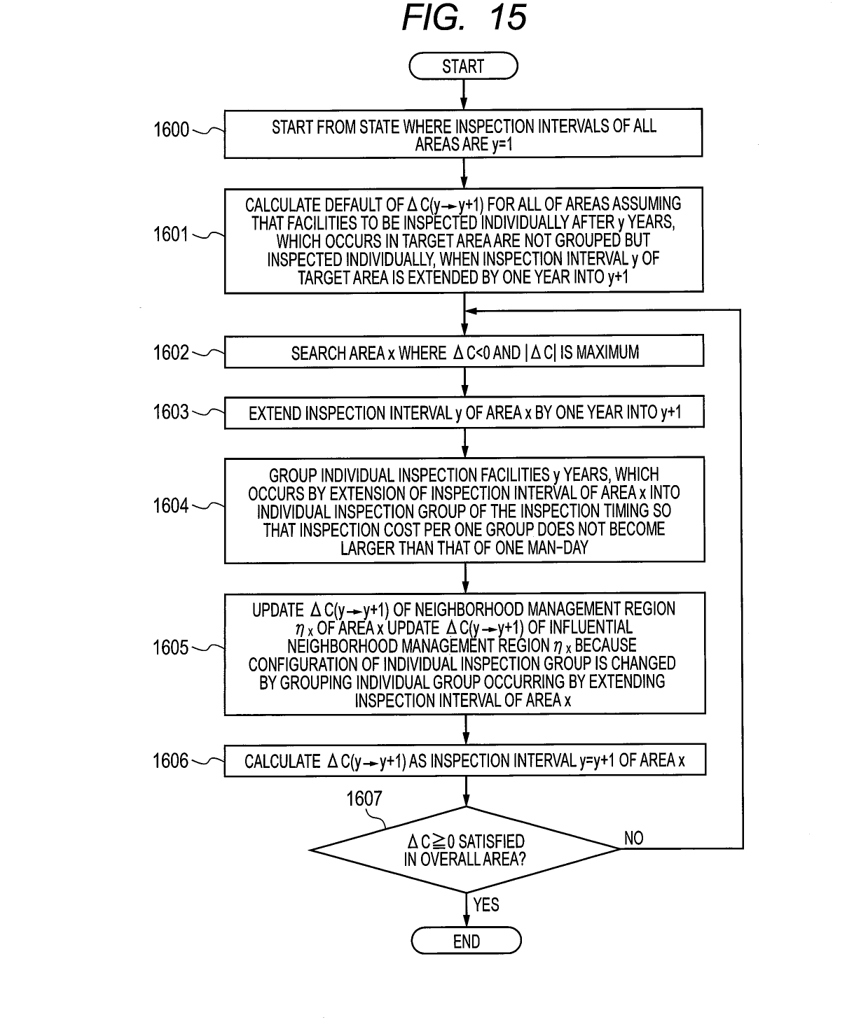

Subsequently, a description will be given of an example of a method of calculating the decision reference value for deciding whether the area inspection interval in each of the maintenance areas can be extended from the current interval, or not, with reference to FIGS. 14A, 14B and 12.

A decision reference value ΔC for deciding whether the area inspection interval to the maintenance area rᵢ can be extended from the current interval, or not, is expressed by Expression 12. In Expression 12, ΔC(rᵢ(yᵢ→yᵢ+1)) represents an increase or decrease value ΔCᵣ(rᵢ(yᵢ→yᵢ+1) of the total inspection costs when the current inspection interval yᵢ of the area rᵢ is extended by 1 year into yᵢ+1. That is, ΔC(rᵢ(yᵢ→yᵢ+1)) is a sum of an increase or decrease value ΔCᵣ(rᵢ(yᵢ→yᵢ+1)) of the area inspection costs when the current inspection interval yᵢ of the area rᵢ is extended by 1 year into yᵢ+1, and an increase or decrease value ΔCg(rᵢ(yᵢ→yᵢ+1)) of the individual inspection costs when the current inspection interval yᵢ of the area rᵢ is extended by 1 year into yᵢ+1.

$$Δ C ( {r}_{i} ( {y}_{i} \to {y}_{i} + 1 ) ) = Δ {C}_{r} ( {r}_{i} ( {y}_{i} \to {y}_{i} + 1 ) ) + Δ {C}_{g} ( {r}_{i} ( {y}_{i} \to {y}_{i} + 1 ) ) \qquad ( 12 )$$

As described above, the costs of the area inspection are calculated by the aid of Expression 5, and the individual inspection costs can be calculated by the same expression as that of Expression 5.

When the current inspection interval yᵢ of the area rᵢ is extended by 1 year into yᵢ+1, the area inspection costs of the area ri are decreased, but it is conceivable that the total individual inspection costs are increased as much as the number of individual inspection targets increased by extending the inspection interval. Hence, if the sum ΔC of ΔCᵣ and ΔC_{g} is negative, when the current inspection interval yᵢ of the area rᵢ is extended by 1 year into yᵢ₊1, the inspection costs are decreased. For that reason, it can be decided that the current inspection interval yᵢ of the area rᵢ may be extended by 1 year into yᵢ+1.

On the other hand, if the sum ΔC of Δᵣ and ΔC_{g} is a positive value of 0 or more, when the current inspection interval yᵢ of the area rᵢ is extended by 1 year into yᵢ+1, the inspection costs are increased. For that reason, it can be decided that the current inspection interval yᵢ of the area rᵢ cannot be extended, and determined to the current inspection interval yᵢ.

The above specific example will be described with reference to FIGS. 14A to 14D. As illustrated in FIGS. 14A and 14B, the current inspection interval of a maintenance area m (1500) is 2 years (1502), a two-year later individual inspection group (1501) has already existed in an area close to the area m (1500), and an inspection route (1511) of the individual inspection group (1501) is determined. In this case, a facility (1504) within the area m, which is predicted to be required to be inspected 2 years later is set as a two-year later individual inspection target (1509) (FIG. 14C), to thereby attempt that the inspection interval of the area m (1500) is changed from 2 years of the current interval (1502) to 3 years (1507) (FIG. 14D).

In this case, decision of whether the interval of the area inspection can be extended from 2 years to 3 years, or not, is considered. In this case, ΔCᵣ(rᵢ(yᵢ→yᵢ+1)) in Expression 12 is calculated by a difference between the inspection costs when the area m (1500) is inspected at the current inspection interval of 2 years, and the inspection costs when the facilities to be subjected to the area inspection other than the facility (1504) predicted to be required to be inspected 2 years later are inspected at the inspection interval of 3 years (1507).

Also, ΔCᵣ(rᵢ(yᵢ→yᵢ+1)) in Expression 12 is calculated as follows. That is, for example, in the area m (1500) where the current inspection interval is set to 2 years (1502), the inspection costs of a two-year later individual inspection group’ (1506) obtained by grouping the two-year later individual inspection target (1509) into the existing two-year later individual inspection group (1501) are calculated by the same expression as Expression 5, and ΔCᵣ(rᵢ→yᵢ+1)) is calculated by a difference between the calculated inspection costs and the inspection costs of the two-year later individual inspection group (1501) calculated by Expression 5.

Then, the decision reference value ΔC(rᵢ(yᵢ→yᵢ+1) for deciding whether the inspection interval of the area m (1500) can be extended from the current interval of 2 years (1502) to 3 years (1507), or not, is calculated by the sum of ΔCᵣ(rᵢ(yᵢ→yᵢ+1)) and ΔC_{g}(ri(yᵢ→yᵢ+1)) as described above.

Subsequently, a description will be given of one example of a specific method of calculating the inspection schedule in which the inspection interval and the individual inspection group are combined together for each of the maintenance areas in order to minimize the total inspection costs of the plurality of areas, on the basis of the decision reference value ΔC(rᵢ(yᵢ→yᵢ+1)) with reference to FIGS. 14A to 14D to 23.

FIG. 15 is a flowchart entirely illustrating an example of inspection schedule creation processing that calculates an inspection schedule in which the inspection interval and the individual inspection group are combined together for each of the maintenance areas in order to minimize the total inspection costs in the plurality of areas.

First, the inspection interval in all of the maintenance areas to be processed is set to 1 year, and the inspection interval is initialized (1600).

Then, a default of ΔC(y→y+1) is calculated for all of the areas. In this situation, when the inspection interval y of the target area is extended by 1 year into yᵢ+1, assuming that the facilities to be subjected to the individual inspection after y years which occur in the target area are not grouped, and inspected, independently, ΔC(y→y+1) is calculated (1601).

Then, an area x having LC which is negative and smallest (absolute value is largest) is retrieved in all of the maintenance areas to be processed (1602). That ΔC is negative and smallest means that the inspection interval of the area x is extended from the current interval y by 1 year whereby the costs can be most reduced in all of the areas.

Then, the current inspection interval y of the area x is extended by 1 year into (y+1) years (1603).

Then, the facilities to be subjected to the individual inspection after y years, which is created by extending the inspection interval of the area x, are grouped into the individual inspection group having the same inspection timing in an area close to the area x (1604). The close area is arbitrarily determined taking to what extent the individual inspection group is increased into account. If the close area is wide, the individual inspection group extends over a large number of maintenance areas, and the movement distance becomes long, which is inefficient. On the other hand, if the close area is narrow, the number of target facilities included in the respective inspection groups becomes small, and emphasis put on the reciprocating movement between the business office and the respective individual inspection groups is increased.

When the individual inspections are grouped into the existing individual inspection group, the inspection costs of the individual inspection group are calculated by using the same expression as Expression 5, and the individual inspections are grouped so that the inspection costs per one group is not larger than one man-day. If the result of the grouping exceeds one man-day, the individual inspections are not grouped.

Then, ΔC(y→y+1) of the area ηx close to the area x is updated (1605). The individual inspection targets generated by extending the inspection interval in the area x are grouped into the existing individual inspection group (1604), to thereby change the configuration of the individual inspection group. For that reason, as illustrated in FIG. 14D, in the individual inspection group after the facilities to be subjected to the individual inspection after y years have been grouped into the existing individual inspection group having the same timing, when the inspection interval y in the areas of the respective close areas ηx is extended by 1 year into (y+1) years, ΔC(y→y+1) is calculated.

Then, because the inspection interval of the area x is extended by 1 year into y+1, ΔC(y→y+1) when y+1 is newly set to y is calculated (1606).

For example, when the inspection interval of the area x retrieved in the processing (1602) is 2 years, that is, ΔC of the area x is ΔC(2→3), the inspection interval of the area x is extended to 2+1=3 years by the processing (1603). When the inspection interval of the area x is changed from 2 years to 3 years, the facilities to be subjected to the individual inspection after 2 years which occur in the area x are grouped into the existing two-year later individual inspection group close to the area x. Because the individual inspection group configuration is changed by grouping the facilities to be subjected to the individual inspection, ΔC(2→3) in the close area ηx that affects the new individual inspection group is updated.

Taking that after the inspection interval in the area x has been changed to 3 years, the inspection interval is extended from 3 years to 4 years into consideration, ΔC(3→4) is calculated.

When ΔC(y→y+1) is calculated by using Expression 5, a reduction in the area inspection costs becomes smaller as the value of y is increased more. For example, when the inspection interval is extended from 2 years to 3 years, the area inspection costs is reduced to about 2/3. However, when the inspection interval is extended from 3 years to 4 years, the area inspection costs is reduced to about 3/4, and the reduction becomes small. On the other hand, with an increase in the area inspection interval, the number of facilities to be subjected to the individual inspection is increased, and the individual inspection costs are increased. Hence, with an increase in y, the value of ΔC is increased from a negative value in a positive direction, and when the value of ΔC reaches 0 or more, if the inspection interval is extended more, the inspection efficiency is deteriorated.

Subsequently, the flow is returned to the processing (1602), and the processing (1602 to 1606) is repeated. Thus, the processing is repeated until ΔC is 0 or more in all of the areas, that is, the inspection interval is not more extended even in any area (1607), and a final inspection schedule is created.

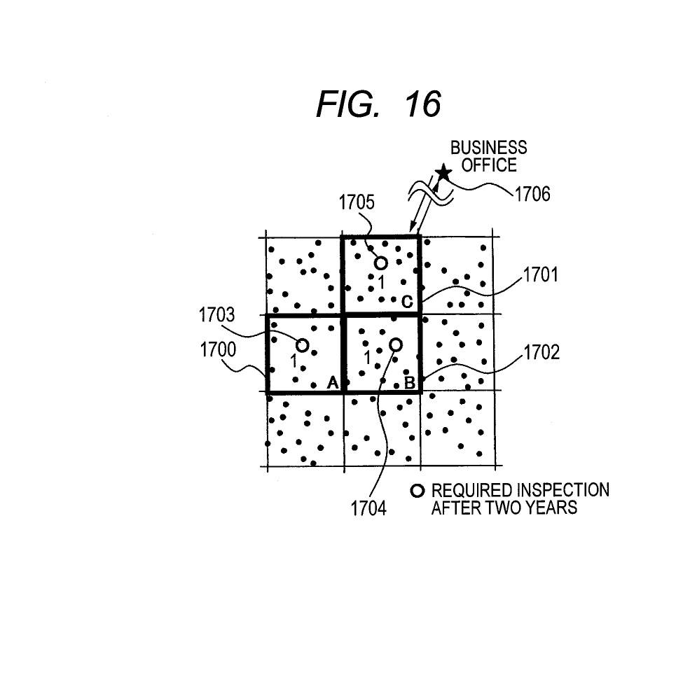

Subsequently, a description will be given of the contents of the processing for calculating the inspection schedule in which the inspection interval and the individual inspection group are combined together for each of the maintenance areas in order to minimize the total inspection costs in the plurality of areas with reference to specific examples of FIGS. 16 to 21.

An area to be subjected to the inspection schedule optimization includes three areas of an area A (1700), an area B (1701), and an area C (1702) illustrated in FIG. 16, and a plurality of facilities is arranged in each of the areas. A business office (1706) exists at a location apart from those three areas to be inspected, and a patrolman goes to those three areas from the business office (1706) for inspection. A facility a (1703) predicted to be required to be inspected after 1 year is located in the area A (1700), a facility b (1704) predicted to be required to be inspected after 1 year is located in the area B (1701), and a facility c (1705) predicted to be required to be inspected after 1 year is located in the area C (1702). In the respective areas, the next inspection timing of the facilities other than the facility a (1703), the facility b (1704), and the facility c (1705) are at least 2 years later.

In this case, first, the inspection interval all of the maintenance areas (area A (1700), area B (1701), and area C (1702)) to be processed is set to 1 year, and the inspection interval is initialized (1600).

Then, a default of ΔC (y→y+1) is calculated for all of the areas. In this situation, when the inspection interval y of the target area is extended by 1 year into yᵢ+1, if the facilities to be subjected to the individual inspection after y years which occur in the target area are not grouped, and inspected, independently, ΔC (y→y+1) is calculated (1601). In a first stage, since it cannot be decided how the individual inspection targets are grouped to minimize the costs, when the inspection interval in each of the areas is extended from 1 year to 2 years, and the facilities to be subjected to the individual inspection, which occur in the respective areas, are inspected, singly and individually, a variation ΔC(y→y+1) of the inspection costs in each area is calculated.

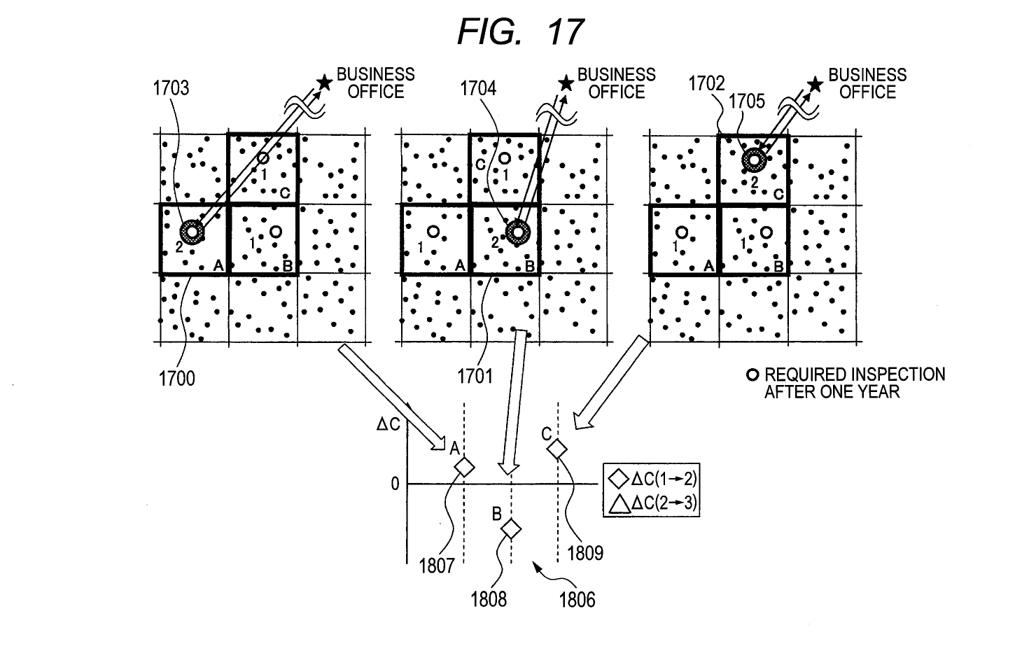

More specifically, as illustrated in FIG. 17, in the area A (1700), a variation ΔCA(1→2) (1807) in the inspection costs when the inspection interval of the area A (1700) is extended to 2 years, and the facility a (1703) predicted to be required to be inspected after 1 year is inspected, singly and individually after 1 year is calculated. Likewise, in the area B (1701), a variation ΔCB(1→2) (1808) in the inspection costs when the inspection interval of the area B (1701) is extended to 2 years, and the facility b (1704) predicted to be required to be inspected after 1 year is inspected, singly and individually after 1 year is calculated. Further, in the area C (1702), a variation ΔCC(1→2) (1809) in the inspection costs when the inspection interval of the area C (1702) is extended to 2 years, and the facility c (1705) predicted to be required to be inspected after 1 year is inspected, singly and individually after 1 year is calculated. When the calculated ΔC is represented in a drawing (1806), a value of ΔC in each of the areas is different due to a difference in the area inspection costs and the individual inspection costs in each of the areas.

Then, in the processing (1602), the area x having ΔC which is negative and smallest is retrieved in all of the maintenance areas to be processed. Since ΔCB (1808) in the area B satisfies the above conditions, the current inspection interval y of the area B is extended by 1 year into 2 years (1603). As a result, the total inspection costs are reduced by ΔCB.

Subsequently, in the processing (1604), the facilities to be inspected, individually, after 1 years, which are generated by extending the inspection interval in the area B are grouped into the individual inspection group having the same inspection timing close to the area B. However, in this example, there is no individual inspection group having the same timing in the close area of the area B (1701), which can group the facility b (1704) to be inspected, individually, after 1 year, which is generated by extending the inspection interval of the area B (1701). Therefore, nothing is conducted in the processing (1604).

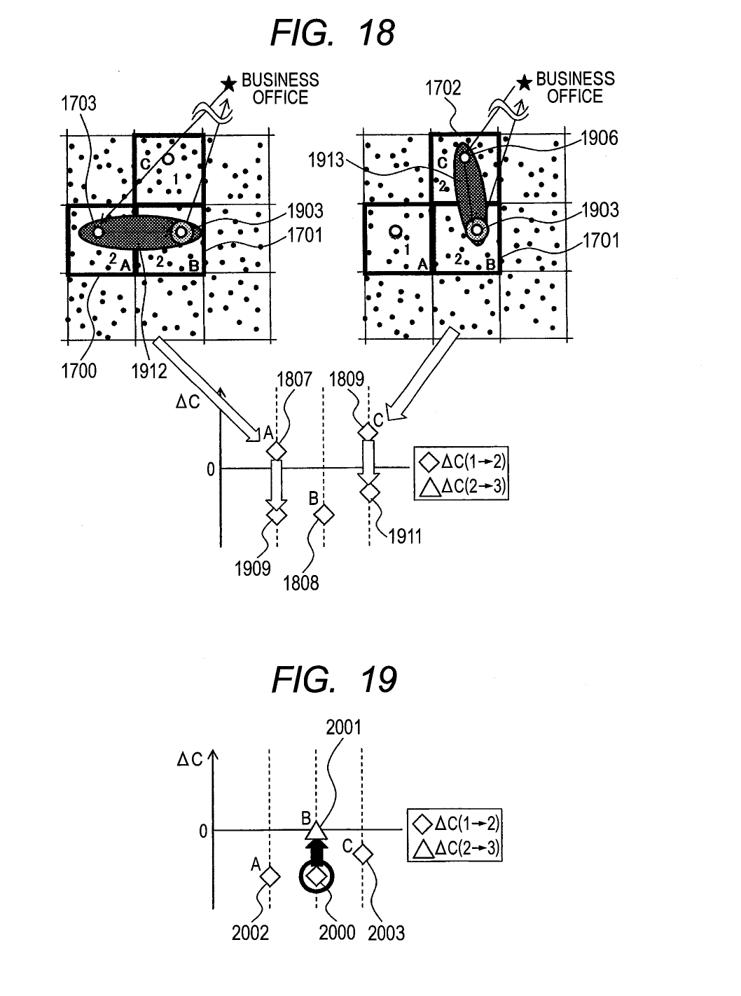

Then, in the processing (1605), ΔC(y→y+1) in the area A (1700) and the area C (1702) close to the area B is updated. In the area A (1700), ΔC is calculated from the inspection costs when the inspection interval is extended to 2 years in the processing (1601), and the facility a (1703) predicted to be required to be inspected after 1 year is inspected, singly and individually, after 1 year. However, in the existing state, the one-year later individual inspection group (1903) has already existed in the area B (1701). For that reason, as illustrated in FIG. 18, ΔCA is calculated from the inspection costs when the facility a (1703) predicted to be required to be inspected after 1 year is grouped into the existing close one-year later individual inspection group (1903) (1912). When the facility a (1703) is grouped into the existing close one-year later individual inspection group (1903), the movement costs required for the individual inspection are reduced more than the case in which the facility a is inspected, singly and individually. As a result, ΔCA becomes smaller than an original value (1807) (1909).

Further, in the area C (1702), ΔC is calculated from the inspection costs when the inspection interval is extended to 2 years in the processing (1601), and the facility c (1705) predicted to be required to be inspected after 1 year is inspected, singly and individually, after 1 year. However, in the existing state, the one-year later individual inspection group (1903) has already existed in the area B (1701). For that reason, ΔCA is calculated from the inspection costs when the facility c (1705) predicted to be required to be inspected after 1 year is grouped into the existing close one-year later individual inspection group (1903) (1913). When the facility c (1705) is grouped into the existing close one-year later individual inspection group (1903), the movement costs required for the individual inspection are reduced more than the case in which the facility c is inspected, singly and individually. As a result, ΔCC becomes smaller than an original value (1809) (1911).

As described above, ΔC is updated taking an influence of grouping of the individual inspection according to the surrounding status into consideration.

Because the inspection interval in the area B is set to 2 years, ΔCB(2→3) is calculated taking a fact that the inspection timing is extended to 3 years in the processing (1606) into consideration. With this operation, as illustrated in FIG. 19, the updated ΔCB(2→3) (2001) becomes larger than ΔCB(1→2) (2000) which has not yet been updated.

Then, in the processing (1607), since ΔC is 0 or lower in at least one area, the flow is returned to the processing (1602).

Then, ΔC which is negative and smallest among ΔC(2002, 2001, and 2003) of the respective areas is ΔCA(2002) in the area A. For that reason, the inspection interval of the area A is extended by 1 year into 2 years (1603).

Then, in the processing (1604), the facility a (1703) predicted to be required to be inspected within the area A (1700) after 1 year is grouped into the existing one-year later individual inspection group (1903) in the area B (1701) (1912).

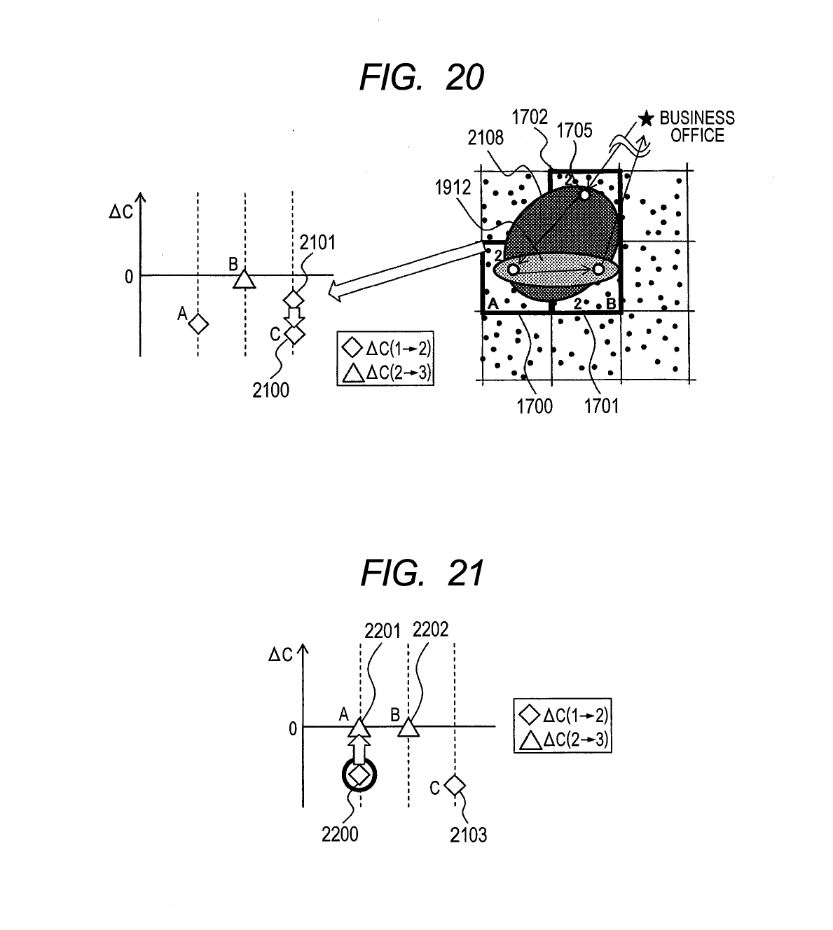

Then, in the processing (1605), ΔC(1→2) in the area C (1702) close to the area A (1700) is updated. As illustrated in FIG. 20, in the area A (1700), in the existing state, since the one-year later individual inspection group (1912) has been already located in the area A (2103) and the area B (2104), ΔCC is calculated from the inspection costs when the inspection interval of the area C (1702) is extended to 2 years, and facility c (1705) predicted to be required to be inspected after 1 year is grouped into the existing close one-year later individual inspection group (1912) (2108). When the facility c (1705) is grouped into the existing close one-year later individual inspection group (1912), the movement costs required for the individual inspection are reduced more than the case in which the facility c is inspected, singly and individually. As a result, ΔCC becomes smaller than an original value (2101) (2100).

Because the inspection interval in the area A is set to 2 years, ΔCA(2→3) is calculated taking a fact that the inspection timing is extended to 3 years in the processing (1606) into consideration. With this operation, as illustrated in FIG. 21, the updated ΔCB(2→3) (2201) becomes larger than ΔCA(1→2) (2200) which has not yet been updated.

Then, in the processing (1607), because ΔC is not 0 or more in at least one controlled area, the flow is again returned to the processing (1602). The same processing is conducted until ΔC in all of the areas becomes 0 or more, that is, the costs are not reduced even if the inspection interval is more extended, to obtain the combination of the final inspection interval and the individual inspection group for each of the areas.

Thus, the facilities required to be inspected, individually, which are generated by extending the inspection interval in the area where an absolute value of ΔC is small are grouped into the other individual inspection group to reduce ΔC. That is, there is a possibility that the effect of reducing the inspection costs by extending the inspection interval becomes large. Hence, the inspection interval is extended in sequence from the area where ΔC is negative and smallest, that is, the area in which the effect of reducing the inspection costs by extending the inspection interval is largest, and the facilities required to be inspected, individually, which are generated by extending the inspection interval in that area are grouped into the other individual inspection group to update ΔC of the surrounding areas. With the above processing, the cost reduction effects caused by grouping the individual inspection can be increased, and the combination schedule of the inspection interval in each of the areas and the individual inspection group, which minimizes the total inspection costs in the plurality of areas can be calculated. The calculated inspection schedule is stored in the inspection schedule data (108).

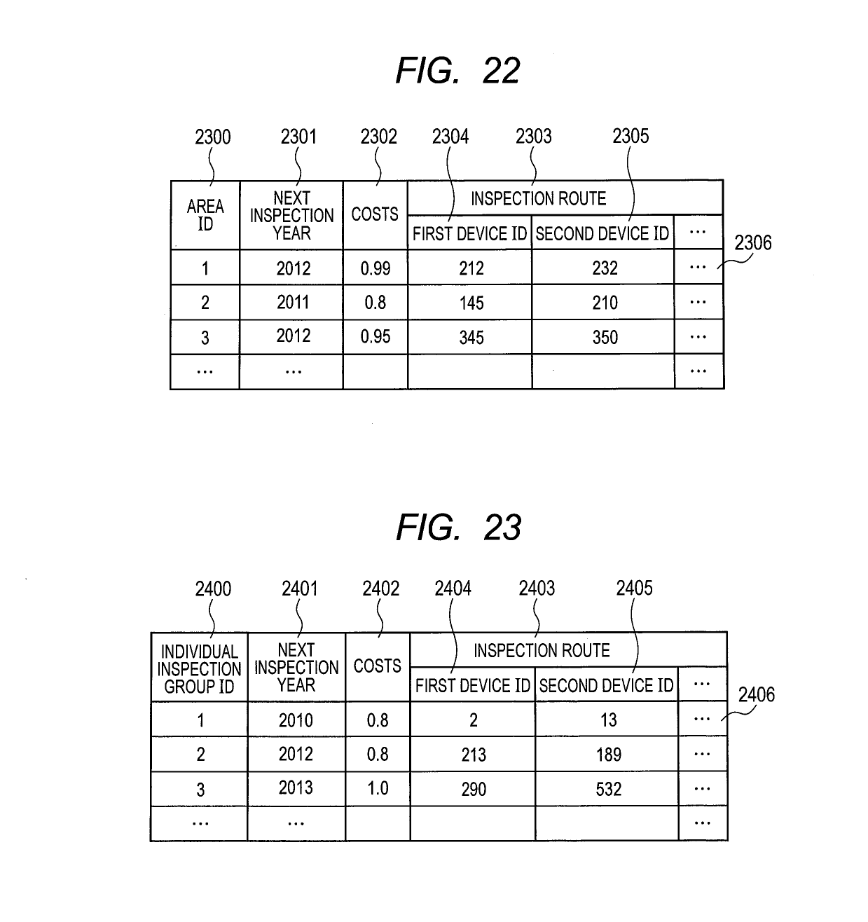

Subsequently, a description will be given of an example of a data structure of the inspection schedule data (108) in which the inspection schedule created by the inspection schedule creation unit (102) is stored, with reference to FIGS. 22 and 23.

FIG. 22 is a diagram illustrating the configuration of a table in which the area inspection schedule is stored.

The table in which the area inspection schedule is stored includes an identifier (2300) of an area, a next inspection year (2301) of the area, inspection costs (2302) of the area, and an inspection route (2303) of the area. In the inspection route (2303) are stored identifiers (2304, 2305) of the devices in the order of inspection. Although not illustrated, in the inspection route (2303) are stored the identifiers of the devices having the same number as that of the facilities to be inspected.

For example, in data (2306), the next inspection year of the area having the area ID of 1 is 2012. As described above, in the inspection schedule creation (201) according to this embodiment, since the inspection interval (Y years) is output for each of the areas, the output inspection interval is added to the current date so that the next inspection year can be calculated. Also, in this embodiment, the inspection costs are indicated by man-hour with the man-day as a unit, and the inspection costs in the area having the area ID of 1 are 0.99 man-day. In the inspection route, the ID of the device to be first inspected is 212, and the ID of the device to be second inspected is 232 in sequence in the inspection route.

FIG. 23 is a diagram illustrating the configuration of the table in which the individual inspection schedule is stored.

The table in which the individual inspection schedule is stored includes an individual inspection group ID (2400), a next inspection year (2401) of the area, inspection costs (2402) of the area, and an inspection route (2403) of the area. In the inspection route (2403) are stored device identifiers in the order of inspection. Although not illustrated, in the inspection route (2403) are stored the identifiers of the devices having the same number as that of the facilities to be inspected.

For example, in the data (2406), the next inspection year of the individual inspection group having the individual inspection group ID of 1 is 2010. As described above, in the inspection schedule creation (201) according to this embodiment, the inspection timing (after Y years) is output for each of the individual inspection groups. Therefore, the output inspection timing is added to the current date so that the next inspection year can be calculated. Also, in this embodiment, the costs are indicated by man-hour with the man-day as a unit. In this embodiment, the inspection costs of the individual inspection group ID 1 are indicated by the man-hour with the man-day as a unit, and 0.8 man-day. In the inspection route, a device ID2 that is first inspected, and a device ID13 that is second inspected are configured in sequence. Although omitted, data is stored as large as the number of the facilities to be inspected. In both of the area inspection and the individual inspection group, the detailed information on the facilities of the target device ID can be obtained with reference to facilities status data 206.

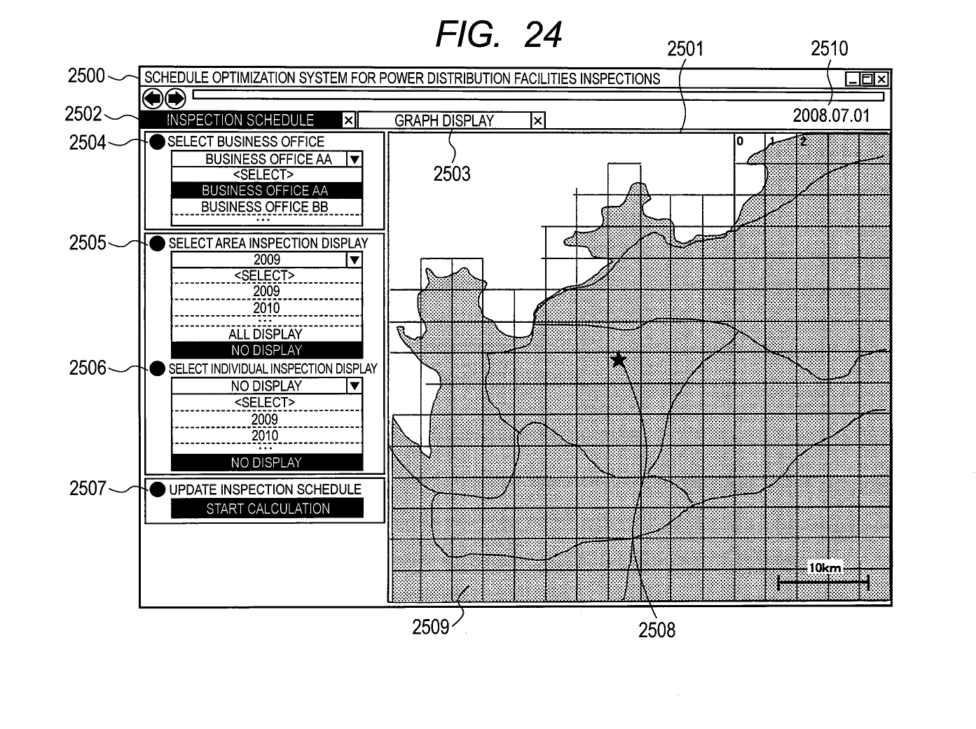

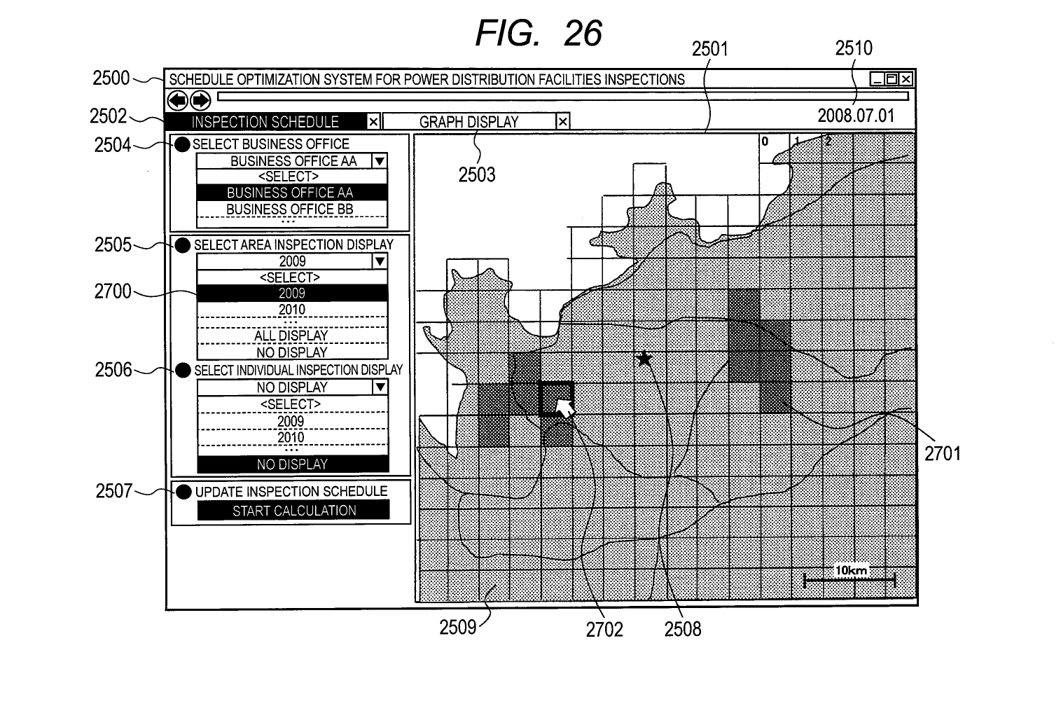

Subsequently, a description will be given of an example of a GUI (graphical user interface) displayed in the input/output unit (103) in order to provide a user of the system (for example, a manager of the inspection schedule, inspection worker) with the inspection schedule data (108), with reference to FIGS. 24 to 30. In this embodiment, the schedule optimization system GUI (2500) for power distribution facilities inspections is realized by a web application, but is not limited to the web application. The schedule optimization system GUI (2500) for power distribution facilities inspections may be realized by windows application (dedicated program).

As illustrated in FIG. 24, the schedule optimization system GUI (2500) for power distribution facilities inspections is configured so that an inspection schedule display page in which the inspection schedule can be confirmed on a map, and a graph display page that displays data such as the inspection costs are selectable. The schedule optimization system GUI (2500) for power distribution facilities inspections also includes a tab (2502, 2503) for selecting display of the respective pages.

When the inspection schedule display page is selected, the input/output unit (103) reads the inspection schedule created by the inspection schedule creation unit (102) from the inspection schedule data (108), links to a GIS (geographic information system), and displays the inspection schedule in the area (2501) where the real map is displayed.

Also, the schedule optimization system GUI (2500) for power distribution facilities inspections includes a business office selection area (2504), an area inspection display selection area (2505), an individual inspection display selection area (2506), an inspection schedule update area (2507), and a current date display (2510). In the business office selection area (2504), a target business office for displaying the inspection schedule for the territory of any business office is selected. In the area inspection display selection area (2505), an implementation year of the area inspection is selected to display an area where the area inspection is implemented in the selected year so as to distinguish from the other areas (for example, highlight display, coloring display, etc.). In the individual inspection display selection area (2506), the year in which the individual inspection is implemented is selected to display the individual inspection group to be implemented in the selected year. When “calculation start” is operated in the inspection schedule update area (2507), the inspection priority calculation processing (201) and the inspection schedule creation processing (102) are executed by the latest history data (107), the facilities status data (106), and the business data (105) to update the latest inspection schedule.

In FIG. 24, since a business office AA is selected in the business office selection area (2504), a business office AA (2508) and a territory (2509) of the business office AA (2508) are displayed on a map. In this example, since none of the area inspection display selection (2505) and the individual inspection display selection (2506) is selected, the inspection schedule is not displayed.

Also, the current date is displayed on the current date display (2510).

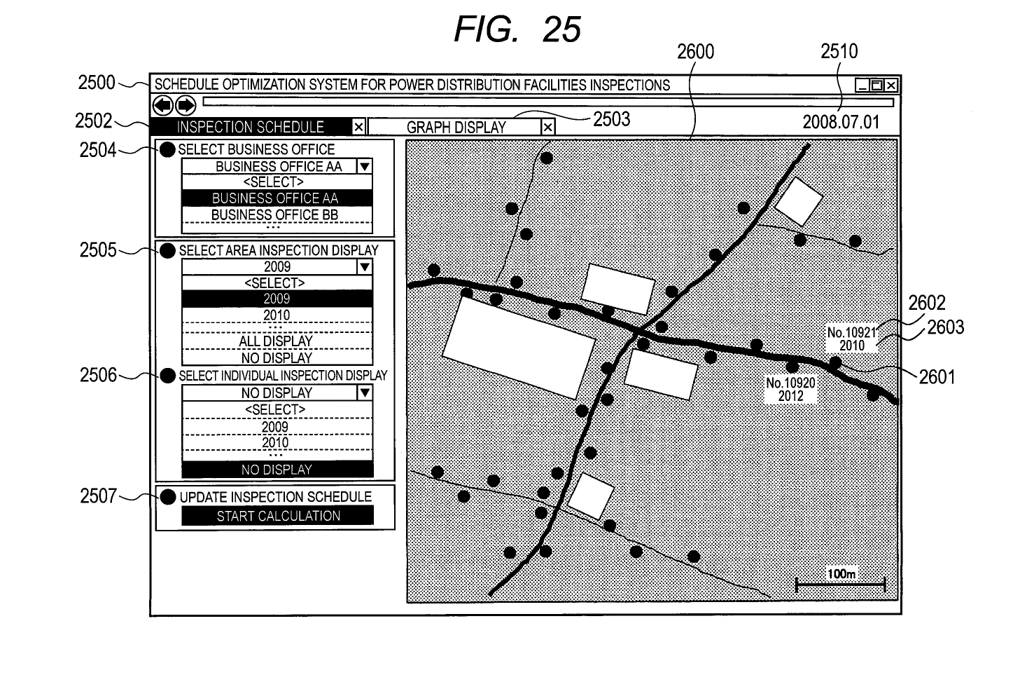

Further, the schedule optimization system for power distribution facilities inspections according to this embodiment links to GIS (geographic information system), and can change a reduction scale of the map by the operation of a mouse wheel. When the reduced scale is increased, as illustrated in FIG. 25, a map (2600) from which the detail of the buildings can be confirmed is displayed, and individual facilities (2601), a device ID (2602) for each facility, and a next inspection timing (2603) are displayed in the map. For example, the device ID (2602) of the facility (2601) is 10921, and it is found that the next inspection timing (2603) is 2010.

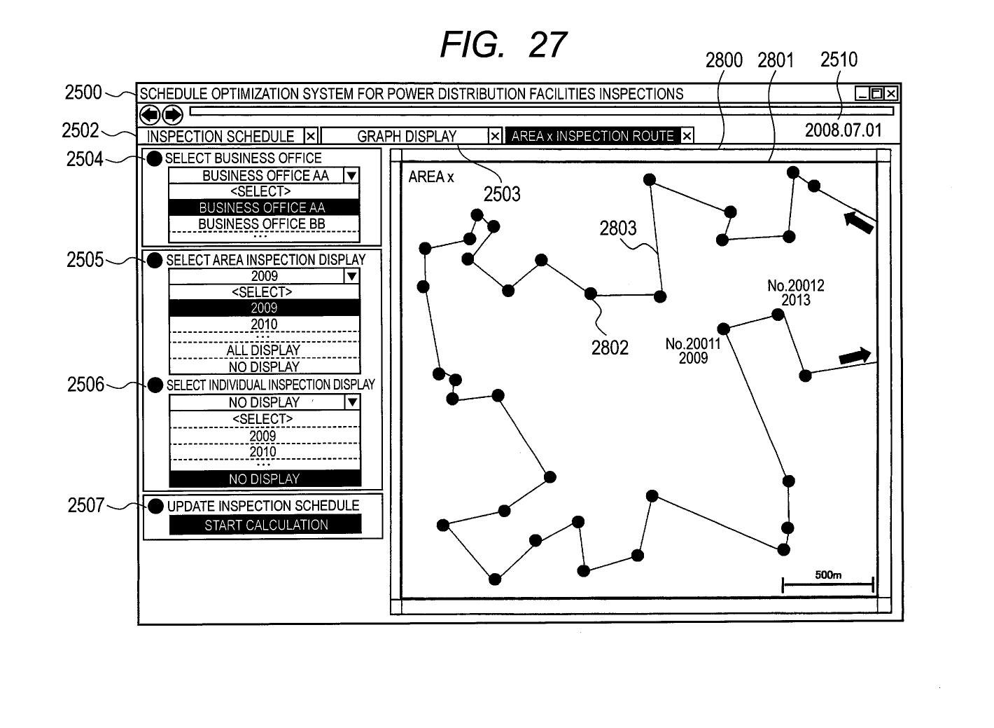

Subsequently, an area inspection display on the inspection schedule display page will be described. In the area inspection display selection area (2505), the implementation year of the area inspection is selected to display an area implemented in the selected year so as to distinguish from the other areas (for example, highlight display, coloring display, etc.). For example, when 2009 is selected (2700) in the area inspection display selection area (2505), an area (for example, 2701) in which the area inspection should be implemented in 2009 is highlighted and displayed on the map. Coloring is conducted for each of the implementation years for display. Further, when a mouse is operated on an area where the detail is to be confirmed (2702), as illustrated in FIG. 27, an inspection route page (2800) of the selected area is newly opened, and a facility (2802) within a selected area (2801) and a route (2803) where the facilities are inspected are selected.

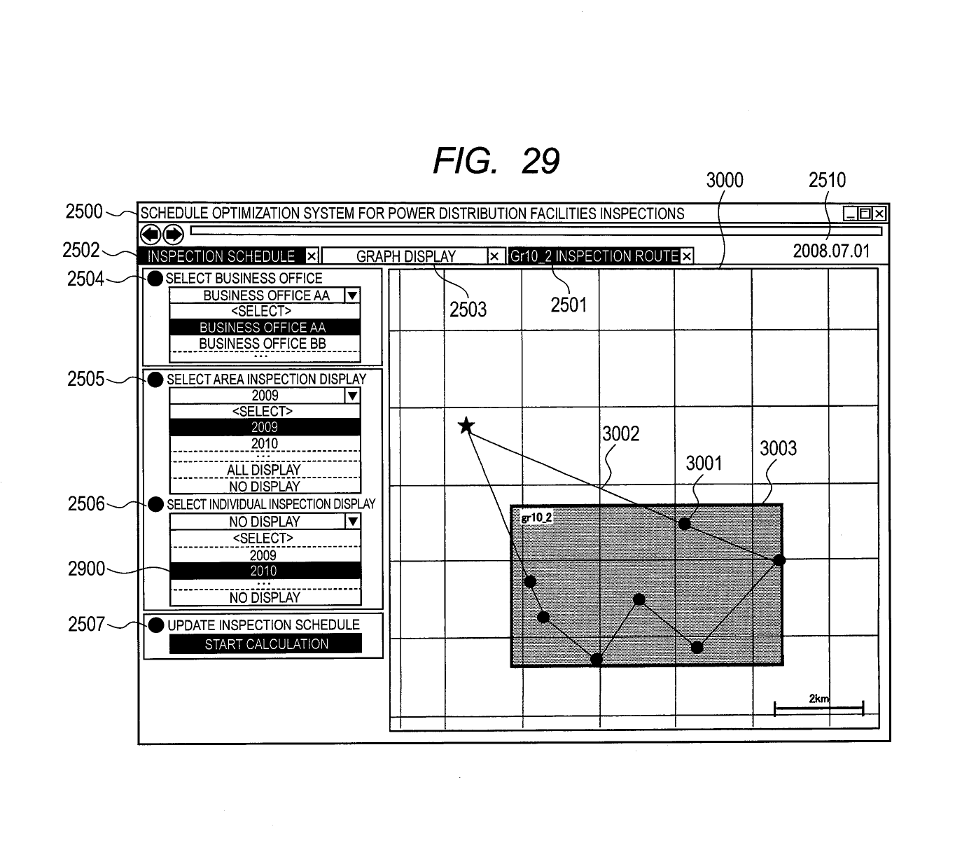

Subsequently, the individual inspection display on the inspection schedule display page will be described. In the individual inspection display selection area (2506), the implementation year of the individual inspection is selected to display the individual inspection group implemented in the selected year so as to distinguish from the other areas (for example, highlight display, coloring display, etc.). For example, when 2010 is selected (2900) in the individual inspection display selection area (2506), an individual inspection group (for example, 2901) on which the individual inspection should be implemented in 2010 is highlighted and displayed on the map. Coloring is conducted for each of the implementation years for display. Further, when a mouse is operated on the individual inspection group (for example, gr10_{—}2) where the detail is to be confirmed (2902), as illustrated in FIG. 29, an inspection route page (3000) of the selected individual inspection group gr10_{—}2 is newly opened, and a facility (3001) within a selected individual inspection group gr10_{—}2 (3003) and a route (3002) where the facilities are inspected are selected.

Subsequently, a graph display page for displaying data such as the inspection costs will be described. The graph display page includes a business office selection area (2504), a year specific necessary inspection cost display area (3101), a year specific area inspection list display area (3107), and a year specific individual inspection list display area (3108), but may display other information.

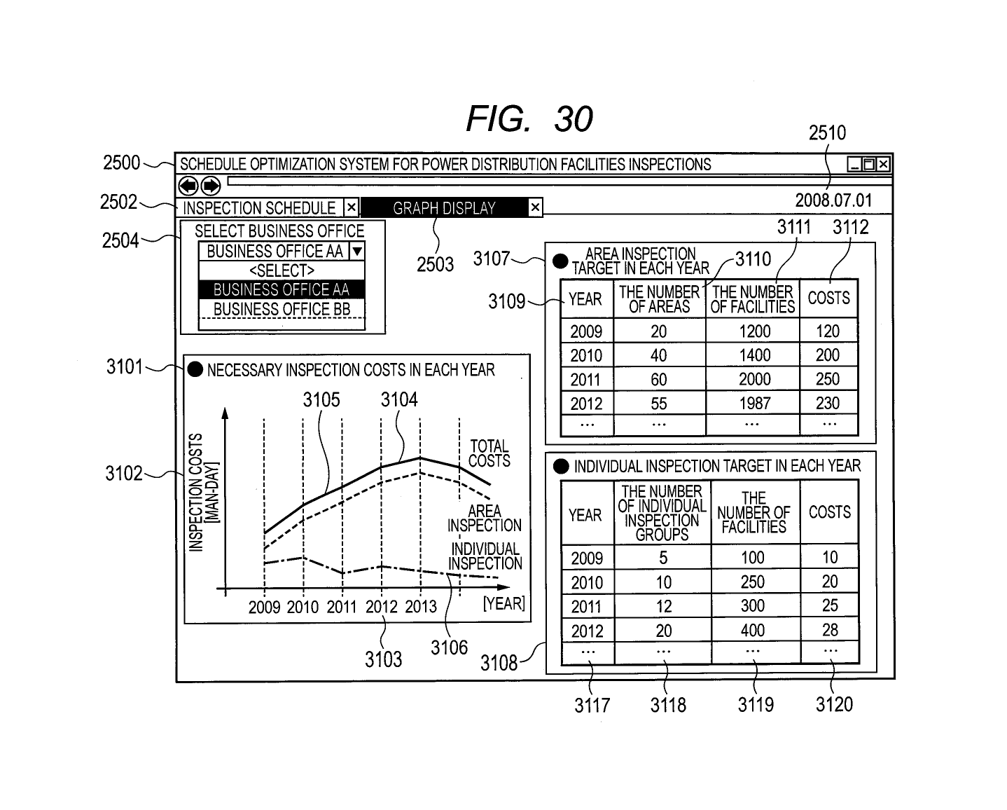

In the graph display page, the business office that displays the graph is first selected in the business office selection area (2504). In a case illustrated in FIG. 30, since the business office AA is selected, a graph and list of the inspection schedule of the business office AA are displayed.

In the year specific necessary inspection cost display area (3101), area inspection costs necessary for each year (3105), individual inspection costs (3106), and total costs (3104) are displayed by a line graph with the axis of abscissa indicative of years (3103), and the axis of ordinate indicative of the inspection costs (3102). The costs displayed in the year specific necessary inspection cost display area (3101) are indicated by the man-hour with the man-day as a unit.

In the year specific area inspection list display area (3107), the number of areas (3110) to be inspected in each year (3109), the number of facilities to be inspected (3111), and inspection costs (3112) are displayed in a table format. FIG. 30 illustrates a state in which data from 2009 to 2012 is displayed. For example, in data (3113) of 2009, the number of areas requiring the inspection in 2009 is 20, the number of facilities within the area is 1200, and the costs of the inspections are 120 man-day.

In a year specific individual inspection target (3108), the number of individual inspection groups to be inspected (3118) in each year (3117), the number of facilities to be inspected (3119), and inspection costs (3120) are displayed in a table format. FIG. 30 illustrates a state in which data from 2009 to 2012 is displayed. For example, in data (3121) of 2009, the number of individual inspection groups requiring the inspection in 2009 is 5, the number of facilities within the group is 100, and the costs of the inspections are 10 man-day.

As described above, according to the first embodiment of the present invention, in order to obtain the inspection interval for each of the inspection areas according to the predicted priority order, the inspection area including the facilities to be inspected which are low in the priority order is enlarged in the inspection interval so that the number of area inspections per time can be reduced, and the inspection costs can be reduced. Also, when the facilities to be inspected which are high in the inspection priority exists within the inspection area, the facilities are excluded from the area inspection target, and included in the individual inspection group so that the inspection interval of the other facilities within the inspection area can be enlarged, and the inspection costs can be reduced. Then, because the optimum inspection schedule including the combination of the inspection interval and the individual inspection group for each of the areas, which minimizes the total inspection costs in the plurality of areas is output, the inspection schedule that reduces the total costs can be obtained.

### Second Embodiment

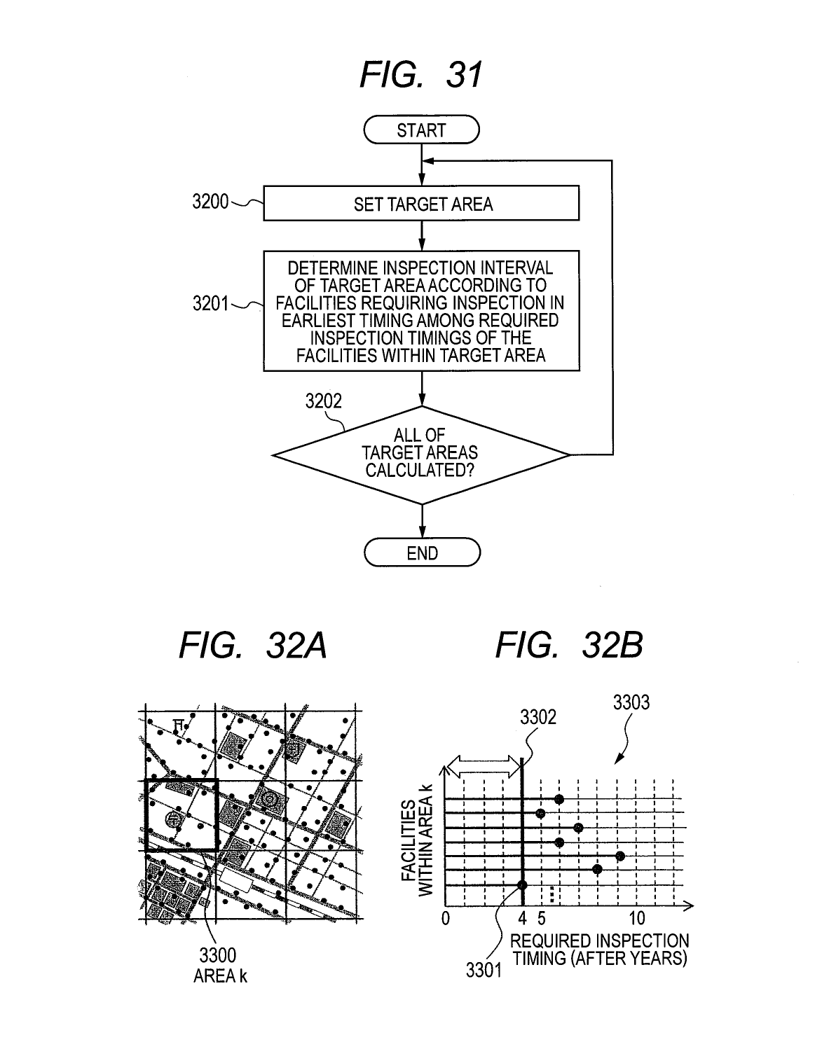

A configuration of a schedule optimization system for power distribution facilities inspections according to a second embodiment of the present invention is identical with that in the above-mentioned first embodiment (FIG. 1). However, in the second embodiment, unlike the first embodiment, in inspection schedule creation processing (202) by an inspection schedule creation unit (102), the inspection interval is changed for each of the areas according to the predicted priority of each facility, and inspection is conducted by only the area inspection. Hence, in the second embodiment, the processing contents of the inspection schedule creation unit (102) will be described with reference to FIGS. 31 and 32A, 32B. The other configuration and processing of the second embodiment are identical with those in the above-mentioned first embodiment, and therefore a description thereof will be omitted.

FIG. 31 is a flowchart of the inspection schedule creation processing (202) by the inspection schedule creation unit (102) according to the second embodiment.

First, an area to be inspected is set (3200), and the inspection interval of the target area is determined on the basis of the facility required to be inspected at the earliest timing among the facilities within the target area (3201). Then, processing (3200, 3201) is repeated on all of the areas (3202).

Subsequently, a specific example of inspection schedule creation processing will be described with reference to FIGS. 32A and 32B.

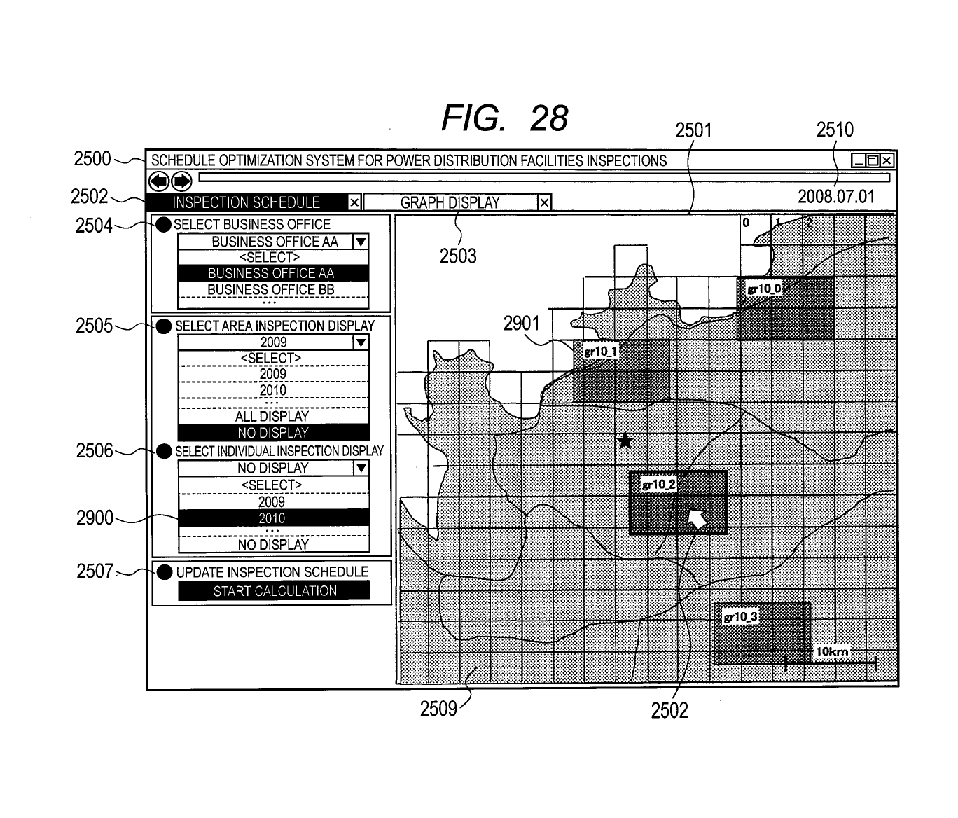

In setting of the target facilities (3200), when the result of calculating the inspection priority of the facilities within the inspection area k (3300) is represented by a next inspection timing distribution (3303), the next inspection timing of the facility (3301) predicted to be required to be inspected at the earliest timing is 4 years later. For that reason, in the processing (3201), the interval of the area inspection is determined to 4 years according to the facility (3301) predicted to be required to be inspected at the earliest timing. In the second embodiment, the inspection interval for each of the areas is changed according to the predicted priority for each of the facilities, and inspection is conducted by only the area inspection. In the second embodiment, because the individual inspection is not conducted, there are not required the display functions of the table (FIG. 23) in which the individual inspection schedule of the inspection schedule data (108), which is the configuration for creation of the individual inspection schedule is stored (FIG. 23) is stored, and the display screen (FIGS. 28 and 29) for the individual inspection among the GUI (2500) of the schedule optimization system for power distribution facilities inspections.

As described above, according to the second embodiment of the present invention, because the area inspection interval is determined according to the facilities of the highest priority within the respective maintenance areas, the inspection interval can be increased while maintaining the reliability, and the inspection schedule that reduces the costs can be obtained.

### Third Embodiment

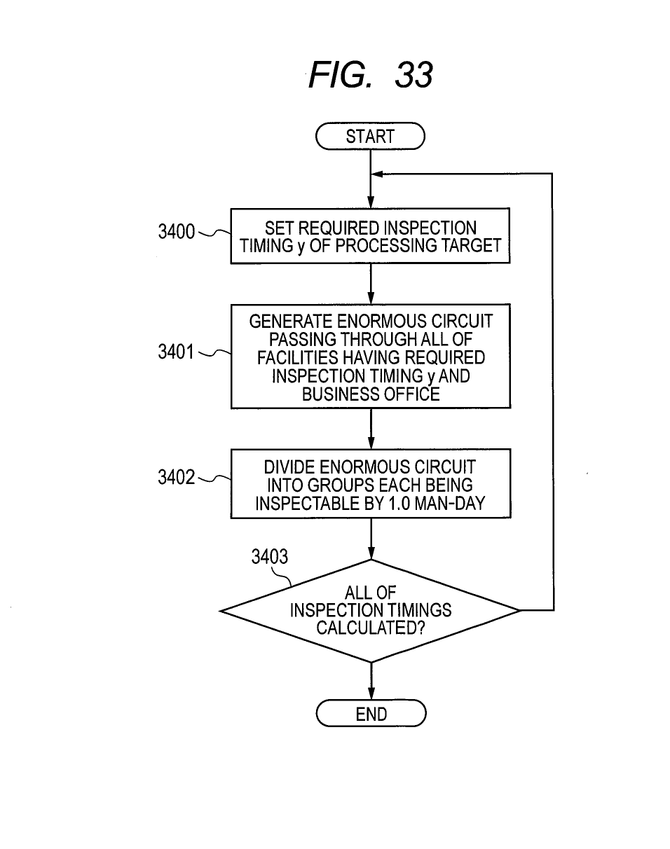

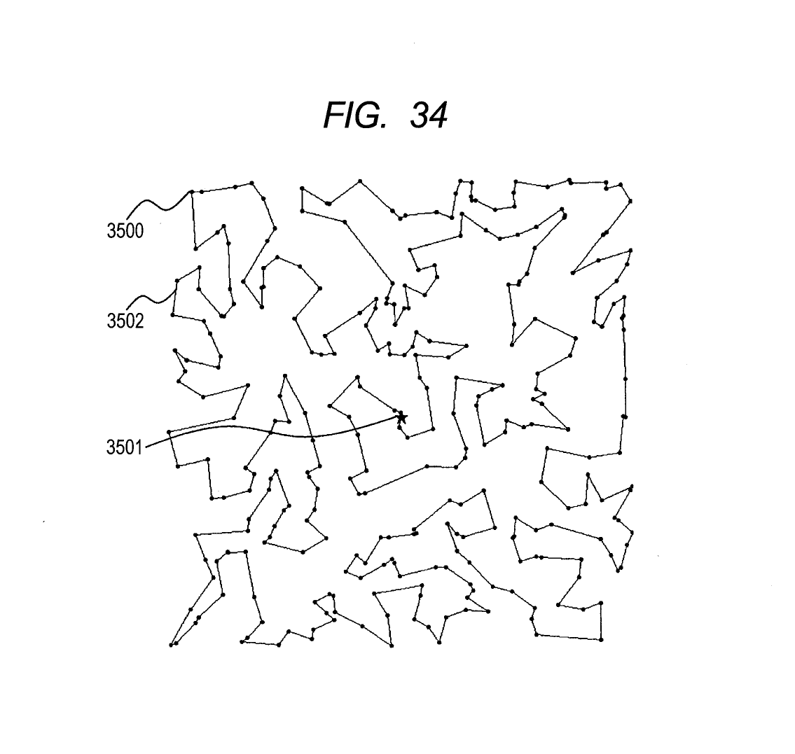

A configuration of the schedule optimization system for power distribution facilities inspections according to a third embodiment of the present invention is identical with those in the above-mentioned first embodiment (FIG. 1). However, in the third embodiment, unlike the first embodiment, in the inspection schedule creation processing (202) by the inspection schedule creation unit (102), the maintenance area is not predetermined, and the group that inspects the facilities at the same time is created according to the predicted priority of each facility, and the range of the group is determined as the maintenance area. Hence, in the second embodiment, the processing contents of the inspection schedule creation unit (102) will be described with reference to FIGS. 33 and 34.

FIG. 33 is a flowchart of the inspection schedule creation processing (202) due to the inspection schedule creation unit (102) according to the third embodiment.

The inspection schedule creation processing (202) according to the third embodiment is based on “route-first cluster-second method” which is one of the solutions to the vehicle routing problem. The next inspection timing y to be processing is first set (3400), and a large circuit that passes through all of the facilities having the next inspection timing of y and the business office is created. In the third embodiment, because the inspection timing is managed in a year unit, the facilities having the same inspection timing are extracted in the processing (3401). On the other hand, when the inspection timing is temporally and more finely set, the facilities having the close inspection timing may be extracted.

FIG. 34 illustrates an example of the circuit generated by the processing (3401). The generated circuit includes a business office (3501), a facility (3500), and a circuit path (3502). The generation of the larger circuit that passes through all of the facilities and the business office generally confronts the traveling salesman problem, and it is difficult to obtain the strict solution when the number of circuits becomes larger. For that reason, solution for obtaining an approximate solution with a realistic time (for example, local search method, generic algorithm, simulated annealing method, etc.) has been proposed.

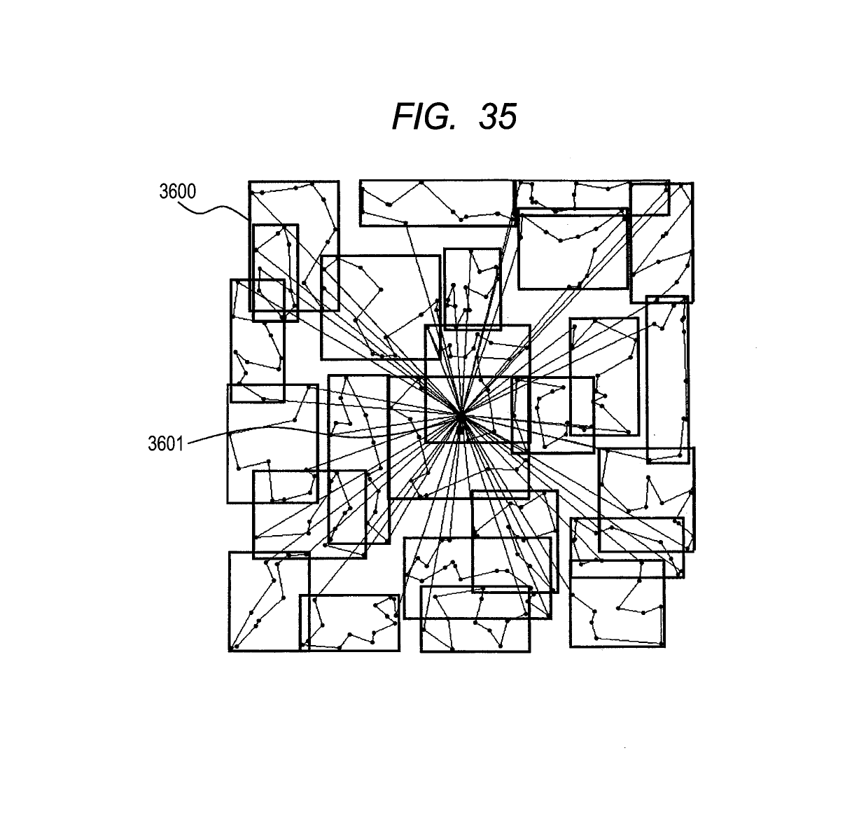

Then, the large circuit is divided into a group that can be inspected by 1.0 man-hour (3402). FIG. 35 illustrates an example of the inspection group created by the processing (3402). The generated circuit is divided into a plurality of inspection groups (3600). The inspection costs are calculated while pursuing the giant circuit from the business office (3601) which is a start point of the inspection, and the circuit till the facility to be inspected before exceeding 1.0 man-hour is classified into a first group, and the same processing is again repeated with the business office (3601) as a start point so that the plurality of inspection groups determining the next inspection timing can be obtained. Then, each group is determined to the inspection area.

In the third embodiment, the facilities having the same inspection timing is classified into an inspection group according to predicted the priority for each of the facilities, and that group is determined to the inspection area. Hence, according to the above configuration, there are not required the display functions of the table in which the individual inspection schedule of the inspection schedule data (108) is stored (FIG. 23) is stored, and the display screen (FIGS. 28 and 29) for the individual inspection among the GUI (2500) of the schedule optimization system for power distribution facilities inspections.

As described above, in the third embodiment, because an optimum inspection area is determined according to the inspection priority and the installation position of the facilities, the efficient inspection schedule can be created.

The present invention has been described above in detail with reference to the attached drawings. However, the present invention is not limited of the specific configuration, but includes various changes and equivalent configurations within departing from the subject matter of the attached claims. For example, the present invention can be applied to the maintenance operation such as the inspection and test of a large number of facilities spread over a wide range, such as the utility poles in the power distribution facilities, running water, gas, or railways,

What is claimed is:

1. A management system for creating an inspection schedule of objects to be tested within a plurality of sectioned management areas, the management system comprising:
a database that stores an inspection time limit and positional information of the objects to be tested;
a calculation unit that calculates the costs for inspecting the objects to be tested on the basis of the positional information; and
a schedule creation unit that creates a schedule for inspecting the objects to be tested on the basis of calculation results,
wherein the calculation unit calculates a first cost required when the objects to be tested within the management areas are inspected at the same timing within a first time limit, and a second cost required when a part of the objects to be tested within the management areas is inspected within the first time limit, individually, and the other objects to be tested within the management areas are inspected at the same timing within a second time limit longer than the first time limit, and
wherein the schedule creation unit compares the calculated first costs with the calculated second costs, and creates an inspection schedule in which the time limits when the objects to be tested within each of the management areas are inspected are combined with the objects to be tested, individually, on the basis of comparison results.

2. The management system according to claim 1,
wherein the schedule creation unit forms the objects to be tested which are inspected, individually, and the objects to be tested which are inspected individually within the other management area into a group, and
wherein the schedule creation unit creates the inspection schedule that inspects the objects to be tested which are included in the group at the same timing.

3. The management system according to claim 1,
wherein the schedule creation unit creates the combination that minimizes the costs per a unit time.

4. The management system according to claim 1,
wherein the schedule creation unit compares the first costs with the second costs by the costs per a unit time.

5. The management system according to claim 1,
wherein the schedule creation unit compares the first costs with the second costs by calculating a difference between the first costs and the second costs in each of the management areas, and
wherein the schedule creation unit stores the calculated difference of the costs as an evaluation index for determining the combination.

6. The management system according to claim 5,
wherein the schedule creation unit creates an inspection schedule that inspects, individually, a part of the objects to be tested within the management area in which the second costs are lowest in the first costs among the evaluation index held by each of the management areas, and inspects the other objects to be tested within the management area at the same timing in the time limit longer than the given time limit.

7. The management system according to claim 1,
wherein the schedule creation unit acquires digitalized map information, and
wherein the schedule creation unit superimposes the created inspection schedule and the information on the objects to be tested which is included in the inspection schedule on the acquired map information, and displays the superimposed information.

8. The management system according to claim 1, further comprising: a priority calculation unit that calculates the priority of the test of the objects to be tested on the basis of the information stored in the database, and calculates the time limit of the inspection according to the calculated priority.

9. The management system according to claim 8,
wherein the priority calculation unit calculates the time limit of the inspection on the basis of an influence rate when the objects to be tested fail, failure information caused by an installation environment of the objects to be tested, and history information that the objects to be tested have been tested or failed in past.

10. The management system according to claim 8,
wherein the time limit of the inspection is determined on the basis of the objects to be tested which are highest in the priority within each of the inspection areas.

11. The management system according to claim 8,
wherein each of the management areas is determined on the basis of the costs calculated on the basis of the priorities of the respective objects to be tested and the positional information.

12. A management method for creating an inspection schedule of objects to be tested within a plurality of sectioned management areas, the management method comprising:
a first step of storing an inspection time limit and positional information of the objects to be tested;
a second step of calculating a first cost required when the objects to be tested within the management areas are inspected at the same timing within a first time limit, on the basis of the positional information;
a third step of calculating a second cost required when a part of the objects to be tested within the management area is inspected in the first time limit, individually, and the other objects to be inspected within the management area are inspected within a second time limit longer than the first time limit at the same timing, on the basis of the positional information;
a fourth step of comparing the calculated first cost with the calculated second cost;
a fifth step of determining the combination of the time limit where the objects to be tested within each of the management areas are inspected with the objects to be tested which are inspected, individually, on the basis of a result of the comparison in the fourth step; and
a sixth step of creating the inspection schedule on the basis of the combination determined in the fifth step.

13. The management method according to claim 12,
wherein the fifth step includes
forming the objects to be tested which are inspected, individually, and the objects to be tested which are inspected within the other management areas, individually, into a group, and
creating the inspection schedule for inspecting the objects to be tested, which are included in the group, at the same timing.

14. The management method according to claim 12,
wherein the fifth step includes determining the combination which are lowest in the costs per a unit time.

15. The management method according to claim 12,
wherein the second step includes calculating the first cost per the unit time,
the third step includes calculating the second cost per the unit time, and
the fourth step includes comparing the first cost with the second cost by the cost per the unit time.
